(19) United States
(12) Patent Application Publication
(10) Pub. No.: US 2019/0012573 A1
(43) Pub. Date: Jan. 10, 2019

(54) CO-CLUSTERING SYSTEM, METHOD AND PROGRAM

(71) Applicant: NEC CORPORATION, Tokyo (JP)

(72) Inventors: Masafumi OYAMADA, Tokyo (JP); Shinji NAKADAI, Tokyo (JP)

(73) Assignee: NEC CORPORATION, Tokyo (JP)

(21) Appl. No.: 15/752,469

(22) PCT Filed: Mar. 3, 2017
(86) PCT No.: PCT/JP2017/008488

§ 371 Date: Feb. 13, 2018

(30) Foreign Application Priority Data
Mar. 16, 2016 (JP) 2016-052737

(51) Int. Cl. G06K 9/62; G06N 7/00; G06N 3/04; G06N 3/08; G06F 15/18

(52) U.S. Cl. CPC G06K 9/6218; G06N 7/005; G06F 15/18; G06N 3/08; G06N 3/0472

(57) ABSTRACT

A co-clustering system capable of further improving prediction accuracy of a prediction model for each cluster is provided. Based on first master data, second master data, and fact data indicating a relation between a first ID which is an ID of a record in the first master data and a second ID which is an ID of a record in the second master data, the co-clustering means 71 executes co-clustering processing of co-clustering the first IDs and the second IDs. The prediction model generation means 72 executes prediction model generation processing of generating a prediction model for each cluster of at least the first ID. The determination means 73 determines whether or not a predetermined condition is satisfied. The prediction model generation processing and the co-clustering processing are repeated until it is determined that the predetermined condition is satisfied.

### TECHNICAL FIELD

The present invention relates to a co-clustering system, a co-clustering method and a co-clustering program for clustering each of two types of matters.

### BACKGROUND ART

Supervised learning typified by regression/discrimination is used for various analysis processing such as demand forecasting of products in retail stores, prediction of power usage amount, and the like. In supervised learning, when a set of input and output is given, a relation between the input and the output is learned and when an unknown input of output is given, its output is predicted based on the learned relation.

In recent years, in order to improve prediction accuracy of supervised learning, techniques for generating a plurality of prediction models one data set, and appropriately selecting prediction models at the time of prediction or appropriately mixing these prediction models have been proposed. This technique is called Mixture of Experts. A technique using a mixed model is described in Non-Patent Literature 1 as one of Mixture of Experts. In the technique described in Non-Patent Literature 1, data (for example, product ID) is clustered based on the property of data (for example, the price of a product), and a prediction model is generated for each cluster. As a result, a prediction model is generated based on “data similar in properties” belonging to the same cluster. Therefore, compared to a case where a prediction model is generated for the entire data, the technique described in Non-Patent Literature 1 can generate a prediction model that takes more detail, thereby improving prediction accuracy.

This specific example is shown below.

Consider, for example, a prediction problem that predicts the number of times that members of a certain service use an aesthetic salon yearly. This prediction problem is a problem of calculating a function that inputs age and outputs the number of times of use. Further, here, it is assumed that the entire data is data for six people. FIG. 23 depicts a diagram illustrating the results of graphically showing age and the number of times of use for the six people. In the graph shown in FIG. 23, an x axis indicates age and a y axis indicates the number of times of use. Furthermore, a prediction model (the above function) is generated by linear regression from the data for the six people and when the function is illustrated, the function can be shown as a straight line shown in FIG. 23. The value of y when substituting the age x for this function is a prediction value of the number of times of use. As can be seen from FIG. 23, the difference between this prediction value and the actual number of times of use is large, and prediction accuracy is low.

On the other hand, it is assumed that the data for six people are divided into two clusters “beauty group” and “drinker group” using the technique described in Non-Patent Document 1. FIG. 24 depicts an example of age, the number of times of use, and prediction model for each cluster in this case. FIG. 24(a) depicts a graph corresponding to “beauty group”, and FIG. 24(b) depicts a graph corresponding to “drinker group”. Also in FIG. 24, an x axis indicates age and a y axis indicates the number of times of use. As can be seen from FIG. 24, it is possible to realize high prediction accuracy in each cluster by collecting data having the same tendency in the same cluster and generating a prediction model for each cluster.

Further, Non-Patent Literature 2 describes learning using an infinite relational model (IRM). In the learning described in Non-patent Literature 2, it is not allowed for unknown values to exist in the data set. For example, it is assumed that a data set used for learning is a set of pairs of a customer ID and values of various attributes of the customer. In the learning described in Non-patent Literature 2, an attribute with an undefined value is not allowed to be present in those attributes.

### CITATION LIST

### Non Patent Literature

NPL 1: Jun Zhu, Ning Chen, Eric P. Xing, “Infinite SVM: a Dirichlet Process Mixture of Large-margin Kernel Machines”, In ICML, pages 617-624.
NPL 2: Charles Kemp, Joshua B. Tenenbaum, Thomas L. Griffiths, Takeshi Yamada, Naonori Ueda, “Learning Systems of Concepts with an Infinite Relational Model”, In AAAI, volume 21, pages 381-338.

### SUMMARY OF THE INVENTION

### Technical Problem

The technique described in Non-Patent Literature 1 clusters data set (for example, customer information) using the value of the attribute owned by the data itself (for example, the age of a customer), and generates a prediction model of unknown attribute (for example, the income of a customer) for each cluster of customers with similar attributes. The unknown attribute is unknown with respect to some of the data among the data, and data whose value of this attribute is known also exists. In the above example, it is assumed that data in which the income of the customer is known and data in which the income of the customer is unknown are mixed. As a result of generating the prediction model in this way, it is possible to generate a prediction model that more closely characterizes each cluster, thereby improving prediction accuracy. However, when correlation between the value of an unknown attribute to be predicted and the value of another attribute is small, improvement of prediction accuracy cannot be expected. For example, in the above example, in a case where there is little correlation between the age of a customer and the annual income of a customer, even if a prediction model that predicts annual income from age is generated for each cluster, improvement of prediction accuracy cannot be expected.

Therefore, it is an object of the present invention to provide a co-clustering system, a co-clustering method and a co-clustering program capable of further improving prediction accuracy of a prediction model for each cluster.

### Solution to Problem

A co-clustering system according to the present invention includes: co-clustering means that performs co-clustering processing that co-clusters first IDs and second IDs based on first master data, second master data, and fact data indicating a relation between the first ID which is an ID of a record in the first master data and the second ID which is an ID of a record in the second master data; prediction model generation means that executes prediction model generation processing that generates a prediction model for each cluster of at least the first ID; and determination means that determines whether or not a predetermined condition is satisfied, wherein the prediction model generation processing and the co-clustering processing are repeated until it is determined that the predetermined condition is satisfied, when the co-clustering means determines a belonging probability that one first ID belongs to one cluster, a value of an objective variable corresponding to the first ID is predicted using the prediction model corresponding to the cluster, and as a difference between the value and an actual value is smaller, the belonging probability becomes higher.

Furthermore, a co-clustering method according to the present invention includes: executing co-clustering processing that co-clusters first IDs and second IDs based on first master data, second master data, and fact data indicating a relation between the first ID which is an ID of a record in the first master data and the second ID which is an ID of a record in the second master data; executing prediction model generation processing that generates a prediction model for each cluster of at least the first ID; and determining whether or not a predetermined condition is satisfied, wherein the prediction model generation processing and the co-clustering processing are repeated until it is determined that the predetermined condition is satisfied, when a belonging probability that one first ID belongs to one cluster is determined in the co-clustering processing, a value of an objective variable corresponding to the first ID is predicted using the prediction model corresponding to the cluster, and as a difference between the value and an actual value is smaller, the belonging probability becomes higher.

Furthermore, a co-clustering program according to the present invention causes a computer to execute: co-clustering processing that co-clusters first IDs and second IDs based on first master data, second master data, and fact data indicating a relation between the first ID which is an ID of a record in the first master data and the second ID which is an ID of a record in the second master data; prediction model generation processing that generates a prediction model for each cluster of at least the first ID; and determining processing that determines whether or not a predetermined condition is satisfied, wherein the prediction model generation processing and the co-clustering processing are caused to be repeated until it is determined that the predetermined condition is satisfied, when a belonging probability that one first ID belongs to one cluster is determined in the co-clustering processing, a value of an objective variable corresponding to the first ID is caused to be predicted using the prediction model corresponding to the cluster, and as a difference between the value and an actual value is smaller, a belonging probability is caused to become higher.

### Advantageous Effects of Invention

According to the present invention, it is possible to further improve the prediction accuracy of the prediction model for each cluster.

### BRIEF DESCRIPTION OF THE DRAWINGS

FIG. 1 It depicts an explanatory diagram showing an example of first master data.

FIG. 2 It depicts an explanatory diagram showing an example of second master data.

FIG. 3 It depicts an explanatory diagram showing an example of fact data.

FIG. 4 It depicts a schematic diagram showing an example of a result of hard clustering.

FIG. 5 It depicts a schematic diagram showing an example of a result of soft clustering.

FIG. 6 It depicts a functional block diagram showing an example of a co-clustering system according to a first exemplary embodiment of the present invention.

FIG. 7 It depicts an explanatory diagram of teacher data used when a prediction model learning unit generates a learning model.

FIG. 8 It depicts a schematic diagram showing an example of a cluster relation.

FIG. 9 It depicts a schematic diagram showing an example of the cluster relation.

FIG. 10 It depicts a schematic diagram showing an example of the fact data.

FIG. 11 It depicts a flowchart showing an example of processing progress of the first exemplary embodiment.

FIG. 12 It depicts an explanatory diagram showing an example of a result of integrating the first master data and the second master data shown in FIG. 1 and FIG. 2, and the fact data shown in FIG. 3.

FIG. 13 It depicts an explanatory diagram showing an example of first master data.

FIG. 14 It depicts an explanatory diagram showing an example of second master data.

FIG. 15 It depicts an explanatory diagram showing an example of fact data.

FIG. 16 It depicts a functional block diagram showing an example of a prediction system according to a second exemplary embodiment of the present invention.

FIG. 17 It depicts a flowchart showing an example of processing progress of the second exemplary embodiment.

FIG. 18 It depicts a functional block diagram showing an example of a co-clustering system according to a third exemplary embodiment of the present invention.

FIG. 19 It depicts a flowchart showing an example of processing progress in a specific example of the first exemplary embodiment.

FIG. 20 It depicts a flowchart showing an example of processing progress in a specific example of the first exemplary embodiment.

FIG. 21 It depicts a schematic block diagram showing a configuration example of a computer according to each exemplary embodiment of the present invention.

FIG. 22 It depicts a block diagram showing an outline of a co-clustering system of the present invention.

FIG. 23 It depicts a diagram illustrating the results of graphically showing age and the number of times of use for six people.

FIG. 24 It depicts a diagram illustrating a result obtained by dividing data for six people into two clusters and graphically showing age and the number of times of use for each cluster.

### DETAILED DESCRIPTION OF THE INVENTION

Hereinafter, exemplary embodiments of the present invention will be described with reference to the drawings.

First, in the present invention, data given in advance will be described. In the present invention, first master data, second master data and fact data are given. The master data may be referred to as dimension data in some cases. Accordingly, the first master data and the second master data may be referred to as first dimension data and second dimension data, respectively. In addition, the fact data may be referred to as transaction data or result data.

The first master data and the second master data each include a plurality of records. The ID of the record of the first master data is written as a first ID. The ID of the record of the second master data is referred to as a second ID.

In each record of the first master data, the first ID and the value of the attribute corresponding to the first ID are associated with each other. However, of the attributes corresponding to the first ID, regarding the specific attribute, the value is unknown in some records.

In each record of the second master data, the second ID and the value of the attribute corresponding to the second ID are associated with each other. It should be noted that, of the attributes corresponding to the second ID, regarding the specific attribute, the value may be unknown in some records. However, in the following description, the second master data will be described by taking as an example a case where the values of all the attributes are defined.

Here, a case where the first ID is a customer ID and the second ID is a product ID will be described by way of example. The first ID and the second ID are not limited to the customer ID and the product ID.

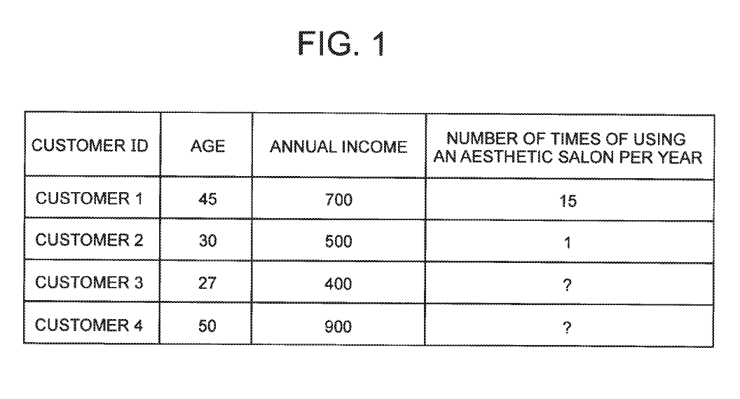

FIG. 1 depicts an explanatory diagram showing an example of first master data. In FIG. 1, “?” Indicates that the value is unknown. In FIG. 1, “age”, “annual income”, and “the number of times of using an aesthetic salon per year” are illustrated as attributes corresponding to the customer ID (first ID). In the records of “customer 1” and “customer 2”, the value of “the number of times of using an aesthetic salon per year” is determined. However, in the records of “customer 3” and “customer 4”, the value of “the number of times of using an aesthetic salon per year” is unknown. The situation where the value becomes unknown in some records arises, for example, in a case where an answer of “the number of times of using an aesthetic salon per year” is obtained from a questionnaire only from some customers, and the like. The values of other attributes (“age”, and “annual income”) are determined for each record. Note that the master data illustrated in FIG. 1 can be said to be customer data.

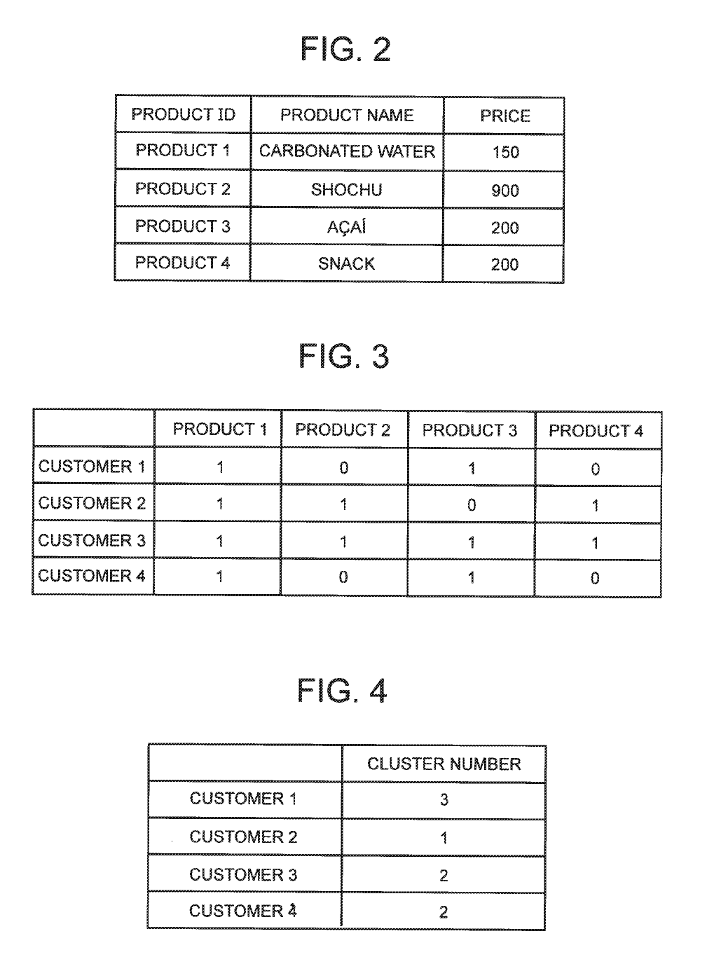

FIG. 2 depicts an explanatory diagram showing an example of second master data. In FIG. 2, “product name” and “price” are illustrated as attributes corresponding to the product ID (second ID). All the values of each attribute shown in FIG. 2 are determined. It is noted that the master data illustrated in FIG. 2 can be said to be product data.

The fact data is data indicating the relation between the first ID and the second ID. FIG. 3 is an explanatory diagram showing an example of fact data. The example shown in FIG. 3 indicates a relation as to whether or not the customer specified by the customer ID (first ID) has the result of purchasing the product specified by the product ID (second ID). In FIG. 3, “1” indicates that the customer has purchased the product, and “0” indicates that the customer does not purchase the product. For example, in the example shown in FIG. 3, “customer 1” has purchased “product 1”, but has never purchased “product 2”. In the fact data, the value indicating the relation between the first ID and the second ID is not limited to binary values (“0” and “1”). For example, the value indicating the relation between the customer ID and the product ID may be the number of times the customer has purchased the product or the like. The fact data illustrated in FIG. 3 can be said to be purchase result data.

Clustering will be described before description of each exemplary embodiment of the present invention. Clustering is a task of dividing data into a plurality of groups called clusters. In clustering, data are classified so that some property is determined in the data and data having similar properties belong to the same cluster. Clustering includes hard clustering and soft clustering.

In hard clustering, each piece of data belongs to only one cluster. FIG. 4 depicts a schematic diagram showing an example of the result of the hard clustering.

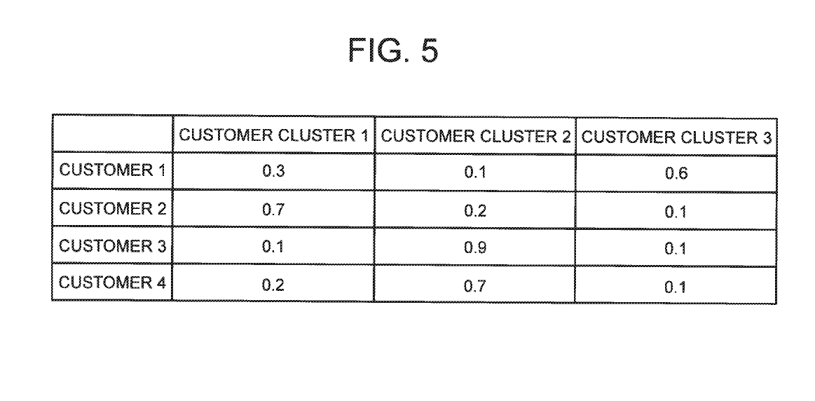

In soft clustering, individual data can belong to multiple clusters. At this time, belonging probabilities representing “how much they belong to clusters” are assigned to each data for each cluster. FIG. 5 depicts a schematic diagram showing an example of the result of soft clustering.

It is to be noted that the hard clustering can be regarded as clustering in which the belonging probabilities of individual data become “1.0” in one cluster and “0.0” in all remaining clusters. That is, the result of hard clustering can also be represented by binary belonging probability. In the process of deriving the result of the hard clustering, the belonging probability in the range of 0.0 to 1.0 may be used. Finally, it is sufficient to set the belonging probability to “1.0” in the cluster where such belonging probability is the maximum and to set the belonging probability of each of the other clusters to “0.0” for each data.

In each exemplary embodiment, hard clustering and soft clustering will be described without distinction, unless otherwise mentioned. Furthermore, the determination of belonging clusters in hard clustering and the determination of belonging probabilities in soft clustering (which may be hard clustering) are described as determination of cluster assignment.

### First Exemplary Embodiment

The inventor of the present invention has examined the processing of co-clustering first IDs and second IDs when the first master data, the second master data, and the fact data are given using an IRM described in Non-Patent Literature 2. Hereinafter, the flow of this processing will be described, and furthermore, in the first exemplary embodiment of the present invention, processing of co-clustering the first IDs and the second IDs when the first master data, the second master data and the fact data are given will be described.

In the co-clustering of the first ID and the second ID, a probabilistic model is held between each cluster of the first ID and each cluster of the second ID (on a direct product space of the cluster). The probabilistic model is typically a Bernoulli distribution representing the strength of the relation between the clusters. When calculating the belonging probability to one cluster with one ID (for example, the first ID), the value of the probabilistic model existing between the cluster and each cluster of the other ID (the second ID in this example) is referred to. For example, when the strength of the relation between clusters is used as a probabilistic model, the probability that a certain customer ID belongs to a certain customer ID cluster is determined by how much the customer indicated by the customer ID has purchased the products indicated by product IDs belonging to a product ID cluster having strong relation with the customer ID cluster. By executing the co-clustering in this way, the customer IDs of customers who buy similar products gather in the same customer ID cluster and the product IDs of products to be bought by similar customers gather in the same product ID cluster.

[Co-Clustering Processing Using IRM Described in Non-Patent Literature 2]

In co-clustering processing using IRM described in Non-Patent Literature 2, the following steps are repeated.

1. A belonging probability to each cluster of the first ID (each cluster having the first ID as an element) and a belonging probability to each cluster of the second ID (each cluster having the second ID as an element) are updated. The belonging probability is determined from the fact data (for example, the purchase result data illustrated in FIG. 3) and attributes corresponding to the first ID and the second ID (for example, the age of the customer or the price of the product).

2.

(2-1) The weight (prior probability) of each cluster of the first ID and the weight (prior probability) of each cluster of the second ID are updated. For example, when there are many records of young people in the first master data (see FIG. 1), the prior probability that the first ID belongs to the cluster of the younger generation is increased.

(2-2) Model information of the cluster is updated based on cluster assignment at the present time, with each cluster having the first ID as an element and each cluster having the second ID as an object. The model information of the cluster is information representing the statistical nature of the value of the attribute corresponding to the ID belonging to the cluster. It can be said that the model information of the cluster expresses the properties of the representative elements of the cluster. For example, the model information of the cluster can be represented by the average or variance of the values of the attributes corresponding to the IDs belonging to the cluster. Since the belonging probability to each cluster of the first ID and the belonging probability of the second ID to each cluster are known, it is possible to calculate the model information of the cluster (for example, the average age of the customer or the average price of the product).

3. A probabilistic model held between each cluster of the first ID and each cluster of the second ID is updated based on the belonging probability of each ID. For example, the relation between a certain customer ID cluster and a certain product ID cluster becomes stronger as there is a relation (for example, purchase result) between the customer ID and the product ID belonging to these clusters.

The steps of “1.” to “3.” are repeated, and when it is determined that the repetition is no longer necessary, the co-clustering processing is ended.

[Co-clustering Processing of the First Exemplary Embodiment of the Present Invention]

In the co-clustering processing according to the first exemplary embodiment of this invention, the prediction model is held for each cluster of the ID (that is, the first ID) of each record in master data (here, the first master data) whose value of a specific attribute is unknown in some records. In this exemplary embodiment, the first ID having similar attribute values belongs to the same cluster, and different prediction models are generated for each cluster, thereby improving the prediction accuracy of the unknown value in the specific attribute.

Further, in the present exemplary embodiment, in determining cluster assignment, the clustering accuracy is improved by setting the belonging probability that the first ID belongs to each cluster to a higher probability as the prediction error of the prediction model corresponding to the cluster is smaller.

In the co-clustering processing according to the first exemplary embodiment of the present invention, the following steps are repeated.

1. In each cluster of the first ID, the prediction model is updated using the value of the attribute corresponding to the first ID belonging to the cluster. For example, the weight of the support vector machine is updated.

2. A belonging probability to each cluster of the first ID (each cluster having the first ID as an element) and a belonging probability to each cluster of the second ID (each cluster having the second ID as an element) are updated. The belonging probability is determined from the fact data (for example, the purchase result data illustrated in FIG. 3) and attributes corresponding to the first ID and the second ID (for example, the age of the customer or the price of the product). When determining the belonging probability of each ID to each cluster, the prediction model for each cluster is also taken into consideration. For example, with respect to a certain first ID, as the prediction accuracy by the prediction model is higher, the belonging probability to the first ID is increased.

3.

(3-1) The weight (prior probability) of each cluster of the first ID and the weight (prior probability) of each cluster of the second ID are updated. For example, when there are many records of young people in the first master data (see FIG. 1), the prior probability that the first ID belongs to the cluster of the younger generation is increased.

(3-2) Model information of the cluster is updated based on cluster assignment at the present time, with each cluster having the first ID as an element and each cluster having the second ID as a target. Since the belonging probability to each cluster of the first ID and the belonging probability of the second ID to each cluster are known, it is possible to calculate the model information of the cluster (for example, the average age of the customer or the average price of the product).

4. A probabilistic model held between each cluster of the first ID and each cluster of the second ID is updated based on the belonging probability of each ID. For example, the relation between a certain customer ID cluster and a certain product ID cluster becomes stronger as there is a relation (for example, purchase result) between the customer ID and the product ID belonging to these clusters.

The steps of “1.” to “4.” are repeated, and when it is determined that the repetition is no longer necessary, the co-clustering processing is ended.

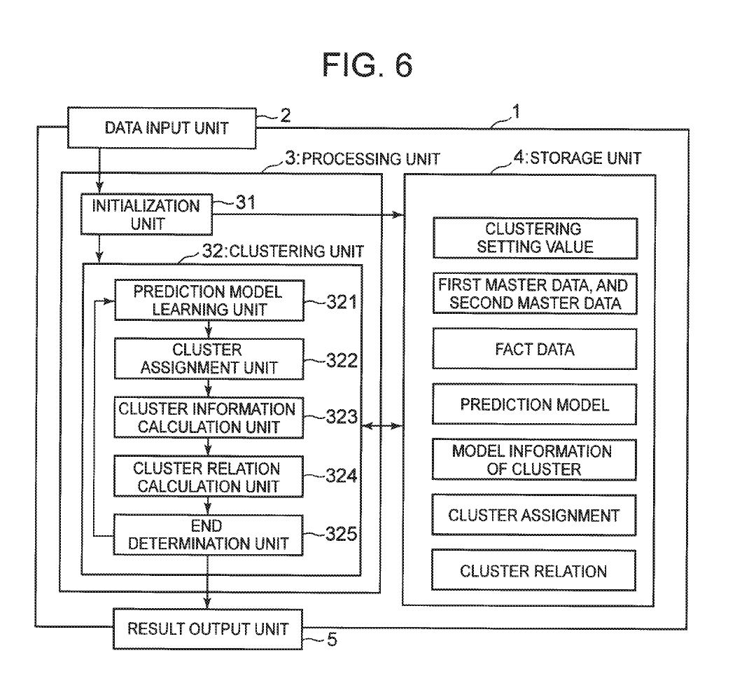

Hereinafter, the first exemplary embodiment of the present invention will be described more specifically. FIG. 6 depicts a functional block diagram showing an example of a co-clustering system according to the first exemplary embodiment of the present invention.

A co-clustering system 1 according to the first exemplary embodiment of the present invention includes a data input unit 2, a processing unit 3, a storage unit 4, and a result output unit 5. The processing unit 3 includes an initialization unit 31 and a clustering unit 32. The clustering unit 32 includes a prediction model learning unit 321, a cluster assignment unit 322, a cluster information calculation unit 323, a cluster relation calculation unit 324, and an end determination unit 325.

The data input unit 2 acquires a data group used for co-clustering and a clustering setting value. For example, the data input unit 2 may access an external device to acquire the data group and the clustering setting value. Alternatively, the data input unit 2 may be an input interface to which the data group and the clustering setting value are input.

The data group used for co-clustering includes the first master data (for example, customer data illustrated in FIG. 1), the second master data (for example, the product data illustrated in FIG. 2), and the fact data (for example, purchase result data illustrated in FIG. 3). Regarding the specific attribute among the attributes of the first master data, the value is unknown in some of the records. It should be noted that the technology described in Non-Patent Literature 2 does not allow attributes having undefined values to be present in input data. That is, in the technique described in Non-Patent Literature 2, missing values of attributes are not allowed. Therefore, a fact that the value of a specific attribute is unknown in some records is different from the technique described in Non-Patent Literature 2.

The clustering setting value includes, for example, the maximum value of the number of clusters of the first ID, the maximum value of the number of clusters of the second ID, designation of master data for generating a prediction model, an attribute to be an explanatory variable in the prediction model, an attribute to be an objective variable in the prediction model, and a type of prediction model.

The prediction model is used to predict the value of a specific attribute whose value is undefined. Therefore, in this example, the first master data is designated as the master data for generating the prediction model. A specific attribute (for example, “the number of times of using an aesthetic salon per year” shown in FIG. 1) is designated as the attribute to be the objective variable in the prediction model.

The type of prediction model includes, for example, a support vector machine, support vector regression, logistic regression, and the like. As the type of prediction model, one of various prediction models is designated.

The initialization unit 31 receives the first master data, the second master data, the fact data, and the clustering setting value from the data input unit 2, and stores them in the storage unit 4. Further, the initialization unit 31 initializes various parameters used for clustering.

The clustering unit 32 implements co-clustering of the first ID and the second ID by repeating processing. Each part of the clustering unit 32 will be described below. Note that it is assumed that the first master data is designated as the master data for generating the prediction model.

The prediction model learning unit 321 learns the prediction model of the attribute corresponding to the objective variable for each cluster relating to the master data (first master data) for generating the prediction model (that is, for each cluster of the first ID).

When clustering is hard clustering, the prediction model learning unit 321 uses the value of the attribute corresponding to the first ID belonging to the cluster as teacher data when generating the prediction model corresponding to the cluster.

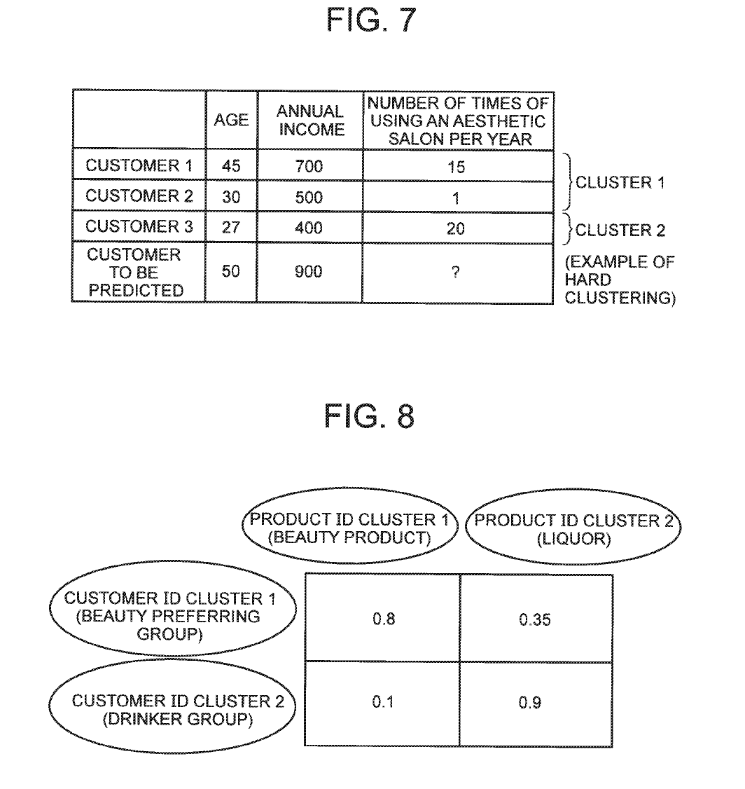

FIG. 7 depicts an explanatory diagram of teacher data used when the prediction model learning unit 321 generates a learning model. For example, it is assumed that customers 1 and 2 shown in FIG. 7 belong only to cluster 1 and customer 3 shown in FIG. 7 belongs only to cluster 2 by hard clustering. In this case, the prediction model learning unit 321 generates a prediction model corresponding to the cluster 1 using the value of each attribute corresponding to the customers 1 and 2 as the teacher data, and generates a prediction model corresponding to the cluster 2 using a value of each attribute corresponding to the customer 3 as teacher data.

When clustering is soft clustering, the prediction model learning unit 321 uses values of attributes of all records that do not include an unknown value as teacher data when generating a prediction model corresponding to the cluster. At this time, the prediction model learning unit 321 weights the value of the attribute of each record by the belonging probability of each first ID to the cluster, and generates a prediction model using the weighted result. Therefore, the teacher data corresponding to the first ID having a high belonging probability to the cluster has a strong influence in the prediction model corresponding to the cluster, and teacher data corresponding to the first ID having a low belonging probability to the cluster has less influence within the prediction model.

A specific example will be described with reference to FIG. 7. In the soft clustering, the customers 1, 2 and 3 shown in FIG. 7 belong to the cluster 1 with their belonging probabilities. The customers 1, 2 and 3 shown in FIG. 7 also belong to the cluster 2 with their belonging probabilities. When generating the prediction model corresponding to the cluster 1, the prediction model learning unit 321 weights the values of the attributes of the customers 1, 2, and 3 with the belonging probability to the clusters 1 of the customers 1, 2, and 3, respectively, and generates a prediction model using the weighted result. The same is true for generating a prediction model corresponding to the cluster 2.

The cluster assignment unit 322 performs cluster assignment for each first ID and each second ID. It can be said that the cluster assignment unit 322 is co-clustering the first IDs and the second IDs. As described above, the result of the hard clustering can also be represented by the binary belonging probability. In the process of deriving the result of the hard clustering, the belonging probability in the range of 0.0 to 1.0 may be used. Here, the operation of the cluster assignment unit 322 will be described using the belonging probability without distinguishing between the hard clustering and the soft clustering.

The cluster assignment unit 322 refers to two pieces of information when executing cluster assignment.

The first piece of information is fact data. In order to make the explanation easy to understand, explanation will be given by exemplifying a case where the first ID is a customer ID and the second ID is a product ID. The probability that a certain customer ID belongs to a certain customer ID cluster is determined by how much the customer specified by the customer ID has purchased the products specified by product IDs belonging to a product ID cluster having strong relation with the customer ID cluster. The same applies to the probability that a certain product ID belongs to a certain product ID cluster. The cluster assignment unit 322 refers to the fact data when calculating the belonging probability to each cluster of the first ID and the belonging probability to the respective clusters of the second ID. Details of this operation will be described later.

Furthermore, second information is the accuracy of a prediction model. The prediction model is generated for each customer ID cluster (cluster with first ID). The cluster assignment unit 322 applies a record corresponding to the customer ID belonging to the customer ID cluster to the prediction model corresponding to the customer ID cluster to calculate the prediction value of the attribute as the objective variable, and calculates a difference between the prediction value and a correct value (the actual value indicated in the record). This difference is the accuracy of the prediction model. The cluster assignment unit 322 corrects the belonging probability of the customer ID so that as the difference is smaller, the belonging probability to the customer ID belonging to the customer ID cluster of interest is increased, and as the difference is larger, the belonging probability to the customer ID belonging to the customer ID cluster of interest is lowered. The cluster assignment unit 322 performs this correction for each customer ID cluster. By this operation, the clustering result is adjusted so that the accuracy of the prediction model is improved.

The cluster information calculation unit 323 calculates model information of each cluster of the first ID and each cluster of the second ID with reference to the cluster assignment (belonging probability) of each first ID and each second ID, and updates the model information of each cluster stored in the storage unit 4. As described above, the model information of the cluster is information representing the statistical nature of the value of the attribute corresponding to the ID belonging to the cluster. For example, in a case where the annual income of each customer follows a normal distribution in each customer ID cluster, the model information of each customer ID cluster is an average value and a variance value in a normal distribution.

The model information of the cluster is used for determination of cluster assignment and calculation of cluster relations to be described later.

The cluster relation calculation unit 324 calculates the cluster relation between each cluster of the first ID and each cluster of the second ID and updates the cluster relation stored in the storage unit 4. The cluster relation is a value representing the property of a combination of clusters. Hereinafter, a case where the cluster relation is a value in the range of 0 to 1 will be described as an example. Based on the fact data, the cluster relation calculation unit 324 calculates cluster relations for each combination of the first ID cluster and the second ID cluster. Therefore, the cluster relation is calculated only by the product of the number of the first clusters and the number of clusters of the second ID. FIG. 8 is a schematic diagram showing an example of cluster relation. In the example shown in FIG. 8, since the number of customer ID clusters is 2 and the number of product ID clusters is 2, the number of cluster relations is 2*2=4. It should be noted that “beauty preferring group”, “beauty product”, and the like shown in FIG. 8 are labels added for convenience by a system administrator based on the contents of the cluster.

As the relation between the first ID belonging to the cluster of the first ID and the second ID belonging to the cluster of the second ID is stronger, the cluster relation in the combination of the two clusters becomes larger value. For example, as the relation between the customer specified by the customer ID belonging to the customer ID cluster and the product specified by the product ID belonging to the product ID cluster is stronger, the cluster relation approaches “1” and as the relation is weaker, the cluster relation approaches “0”. In the example shown in FIG. 8, a lot of customer IDs of customers of beauty preferring group belong to the customer ID cluster 1. Furthermore, a lot of customer IDs of customers of drinker group belong to the customer ID cluster 2. Furthermore, a lot of product IDs of beauty products belong to the product ID cluster 1. For example, the cluster relation between the customer ID cluster 1 and the product ID cluster 1 is 0.9, which is close to 1. This means that the customer specified by the customer ID belonging to the customer ID cluster 1 often purchases the product specified by the product ID belonging to the product ID cluster 1 (the relation is strong). In addition, the cluster relation between the customer ID cluster 2 and the product ID cluster 1 is 0.1, which is close to 0. This means that the customer specified by the customer ID belonging to the customer ID cluster 2 is less likely to purchase the product specified by the product ID belonging to the product ID cluster 1 (the relation is weak).

The cluster relation calculation unit 324 may calculate the cluster relation by calculating the following expression (A).

$$\begin{matrix}[ Expression 1 ] & \\ \frac{{\hat{a}}_{{k}_{1} {k}_{2}}^{[ 1 ]}}{{\hat{a}}_{{k}_{1} {k}_{2}}^{[ 1 ]} + {\hat{b}}_{{k}_{1} {k}_{2}}^{[ 1 ]}} & ( A )\end{matrix}$$

In the expression (A), k₁ represents the ID of the cluster of the first ID, and k₂ represents the ID of the cluster of the second ID. Also, a^{[1]}ₖ₁ₖ₂, and b^{[1]}ₖ₁ₖ₂ are parameters used for calculation of cluster relation. As the value of a^{[1]}ₖ₁ₖ₂ is larger, the relation between k₁ and k₂ is strong and as b^{[1]}ₖ₁ₖ₂ is larger, the relation between k₁ and k₂ is weak. In the text of this specification, the hat symbol shown in the mathematical expression is omitted.

The cluster relation calculation unit 324 may calculate a^{[1]}ₖ₁ₖ₂ by a following expression (B). Further, the cluster relation calculation unit 324 may calculate b^{[1]}ₖ₁ₖ₂ by a following expression (C).

$$\begin{matrix}[ Expression 2 ] & \\ {\hat{a}}_{{k}_{1} {k}_{2}}^{[ 1 ]} = {a}_{0}^{[ 1 ]} + {\sum }_{{d}_{1}}^{{D}^{( 1 )}} {\sum }_{{d}_{2}}^{{D}^{( 2 )}} {φ}_{{d}_{1} , {k}_{1}}^{( 1 )} {φ}_{{d}_{2} , {k}_{2}}^{( 2 )} {x}_{{d}_{1} {d}_{2}} & ( B ) \\ [ Expression 3 ] & \\ {\hat{b}}_{{k}_{1} {k}_{2}}^{[ 1 ]} = {b}_{0}^{[ 1 ]} + {\sum }_{{d}_{1}}^{{D}^{( 1 )}} {\sum }_{{d}_{2}}^{{D}^{( 2 )}} {φ}_{{d}_{1} , {k}_{1}}^{( 1 )} {φ}_{{d}_{2} , {k}_{2}}^{( 2 )} ( 1 - {x}_{{d}_{1} {d}_{2}} ) & ( C )\end{matrix}$$

In the expressions (B) and (C), it is assumed that d₁ represents the order of the first ID and D⁽¹⁾ represents the total number of the first ID. Similarly, it is assumed that d₂ represents the order of the second ID and D⁽²⁾ represents the total number of the second IDs. In expressions (B) and (C), φ_{d1,k2}⁽¹⁾ is the probability that a d₁-th first ID belongs to a cluster k₁. φ_{d2,k2}⁽²⁾ is the probability that a d₂-th second ID belongs to a cluster k₂. x_{d1d2} is the value in the fact data corresponding to the combination of d₁ and d₂.

Here, processing in which the cluster assignment unit 322 refers to the fact data to calculate the belonging probability to the cluster of the ID will be described in detail. Here, the customer ID (first ID) is represented by a variable i. Furthermore, the product ID (second ID) is represented by a variable j. Furthermore, the ID of the customer ID cluster is represented by a variable k₁. The ID of the product ID cluster is represented by a variable k₂.

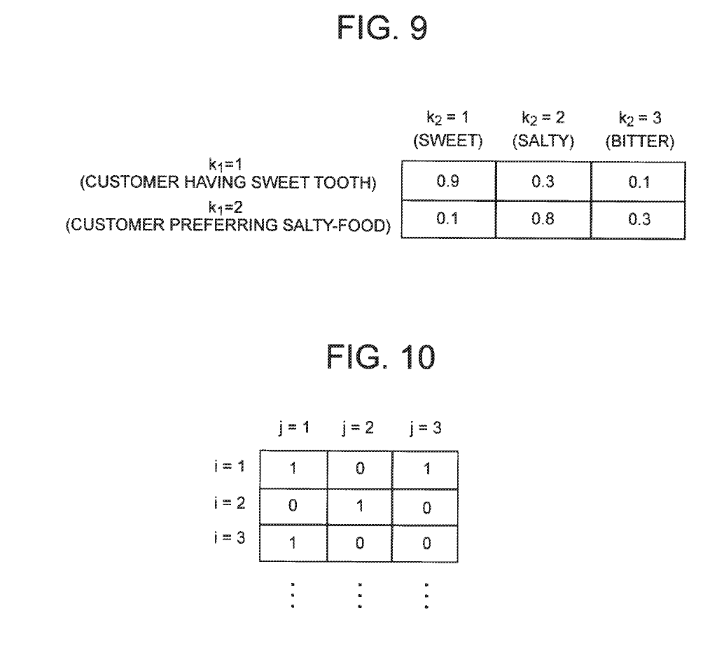

Furthermore, it is assumed that the cluster relation illustrated in FIG. 9 is obtained. It is assumed that a cluster that corresponds to k₁=1 contains a lot of customer IDs having sweet tooth customers. It is assumed that the cluster that corresponds to k₁=2 contains a lot of customer IDs of customers preferring salty-food. It is assumed that cluster that corresponds to k₂=1 contains a lot of product IDs of sweet products. It is assumed that cluster that corresponds to k₂=2 contains a lot of product IDs of salty products. It is assumed that the cluster that corresponds to k₂=3 contains many product IDs of bitter products. In addition, it is assumed that the “sweet tooth”, “sweet” and the like shown in FIG. 9 are labels added for convenience by a system administrator based on the contents of the cluster.

Further, it is assumed that the fact data illustrated in FIG. 10 is given.

Here, a description will be given by exemplifying a case where the cluster assignment unit 322 calculates the probability that a customer that corresponds to i=1 belongs to a cluster that corresponds to k₁=2. Furthermore, the probability that i belongs to the cluster k₁ is written as q(zᵢ⁽¹⁾=k₁). Therefore, the probability that a customer that corresponds to i=1 belongs to a cluster that corresponds to k₁=2 is expressed as q(z₁⁽¹⁾=2). Furthermore, the probability that j belongs to cluster k₂ is described as q(zⱼ⁽²⁾=k₂).

The cluster assignment unit 322 calculates q(z₁⁽¹⁾=2) by the calculation of the following expression (D).

$$\begin{matrix}[ Expression 4 ] & \\ q ( {z}_{1}^{( 1 )} = 2 ) ∝ {\sum }_{j} {\sum }_{{k}_{2}} ( {z}_{j}^{( 2 )} = {k}_{2} ) {E}_{q} [ log p ( {x}_{i = 1 , j} ) \vert {θ}_{{k}_{1} - 2 , {k}_{2}} ] & ( D )\end{matrix}$$

In the formula (D), x is a value in the fact data (see FIG. 10) corresponding to the combination of i and j of a suffix. Therefore, in the example shown in FIG. 10, x is 1 or 0. Furthermore, θ is a cluster relation corresponding to the combination of the suffixes k₁ and k₂.

E_{q} is an operation for calculating the expected value of the probability, and E_{q}[log p(x_{i=1,j})|θ_{k1=2,k2}] is an expected value of the probability that the customer i=1 purchases the product j when j is assumed to belong to the cluster k₂.

The cluster assignment unit 322 also calculates the probability that the customer ID of interest belongs to another customer ID cluster by the same calculation. In the case of hard clustering, the cluster assignment unit 322 may determine that the focused customer ID belongs only to the customer ID cluster in which the belonging probability obtained as a result is the highest. The cluster assignment unit 322 also calculates the probability of belonging to each customer ID cluster for other customer IDs.

Further, the cluster assignment unit 322 also calculates the probability that each product ID belongs to each product ID cluster by the same calculation.

Furthermore, after calculating the belonging probability, the cluster assignment unit 322 may execute correction of the belonging probability using the prediction model.

The clustering unit 32 repeats processing by the prediction model learning unit 321, processing by the cluster assignment unit 322, processing by the cluster information calculation unit 323, and processing by the cluster relation calculation unit 324.

The end determination unit 325 determines whether or not to repeat the above series of processing. When the end condition is satisfied, the end determination unit 325 determines to end the repetition of the above series of processing, and when the end condition is not satisfied, determines that the repetition is continued. An example of the end condition will be described below.

For example, the number of repetitions of the series of processing described above may be determined within the clustering setting value. The end determination unit 325 may determine to end the repetition when the number of repetitions of the above series of processing has reached a predetermined number.

In addition, for example, when the cluster assignment unit 322 executes determination of cluster assignment, clustering accuracy may be derived and the clustering accuracy may be stored in the storage unit 4. The end determination unit 325 calculates the amount of change to the clustering accuracy derived most recently from the clustering accuracy derived last time, and if the amount of change is small (specifically, if the absolute value of the change amount is equal to or less than the predetermined threshold value), it may be determined to end the repetition.

In the case of soft clustering, the cluster assignment unit 322 may calculate the likelihood of the clustering model, for example, as the clustering accuracy. Further, in the case of hard clustering, the cluster assignment unit 322 may calculate, for example, Pseudo F as the clustering accuracy.

The storage unit 4 is a storage device that stores various data acquired by the data input unit 2 and various data obtained by processing of the processing unit 3. The storage unit 4 may be a main storage device of a computer or a secondary storage device. When the storage unit 4 is a secondary storage device, the clustering unit 32 can suspend the processing midway and restart thereafter. In addition, the storage unit 4 is divided into the main storage device and the secondary storage device, and the processing unit 3 may store a part of the data in the main storage device and may store the other data in the secondary storage device.

The result output unit 5 outputs the result of processing by the clustering unit 32 stored in the storage unit 4. Specifically, as a result of the processing, the result output unit 5 outputs all or part of the prediction model, the cluster assignment, the cluster relation, and the model information of the cluster. Cluster assignment is the belonging probability to each cluster of individual first IDs and the belonging probability to each cluster of individual second IDs. Furthermore, in the case of hard clustering, the cluster assignment may be information indicating directly which cluster each individual first ID belongs to and information directly indicating which cluster each individual second ID belongs to.

As aspect in which the result output unit 5 outputs the result is not particularly limited. For example, the result output unit 5 may output the result to another device. Furthermore, for example, the result output unit 5 may cause the display device to display the result.

The clustering unit 32 including the prediction model learning unit 321, the cluster assignment unit 322, the cluster information calculation unit 323, the cluster relation calculation unit 324, and the end determination unit 325, and the data input unit 2, the initialization unit 31, and the result output unit 5 are realized by, for example, a CPU of a computer operating according to a program (co-clustering program). In this case, the CPU reads the program from a program recording medium such as a program storage device (not shown in FIG. 6) of the computer, for example, and in accordance with the program, the CPU may operate as the data input unit 2, the initialization unit 31, the clustering unit 32, and the result output unit 5.

In addition, each element in the co-clustering system 1 shown in FIG. 6 may be realized by dedicated hardware.

Furthermore, the system 1 of the present invention may have a configuration in which two or more physically separated devices are connected by wired or wireless connection. This point is the same in each of the exemplary embodiments described later.

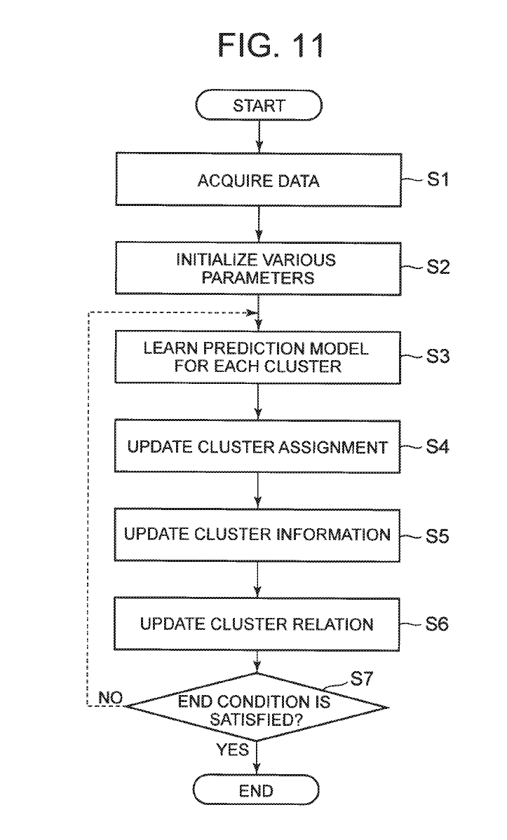

Next, the processing progress of the first exemplary embodiment will be described. FIG. 11 depicts a flowchart showing an example of processing progress of the first exemplary embodiment.

The data input unit 2 acquires a data group (first master data, second master data, and fact data) used for co-clustering and a clustering setting value (step S1).

The initialization unit 31 stores the first master data, the second master data, the fact data, and the clustering setting value in the storage unit 4. Further, the initialization unit 31 sets initial values for “model information of cluster”, “cluster assignment” and “cluster relation”, and stores the initial value in the storage unit 4 (step S2).

The initial value in step S2 may be arbitrary. Alternatively, the initialization unit 31 may derive each initial value, for example, as shown below.

The initialization unit 31 may calculate the average value of the attribute values in the first master data and may determine the average value as the model information of the clusters in all clusters of the first ID. Similarly, the initialization unit 31 may calculate the average value of the attribute values in the second master data and may determine the average value as the model information of the clusters in all clusters of the second ID.

The initialization unit 31 may determine the initial value of the cluster assignment as follows. In the case of hard clustering, the initialization unit 31 randomly assigns each first ID to one of the clusters, and similarly assigns each second ID to any cluster at random. In the case of soft clustering, the initialization unit 31 uniformly determines the belonging probability to each cluster for each first ID. For example, when the number of clusters of the first ID is two, the belonging probability of each first ID to the first cluster and the second belonging probability are set to 0.5, respectively. Similarly, the initialization unit 31 uniformly determines the belonging probability to each cluster for each second ID.

The initialization unit 31 may set the cluster relation to the same value (for example, 0.5 or the like) for each combination of the cluster of the first ID and the cluster of the second ID.

After step S2, the clustering unit 32 repeats the processing of steps S3 to S7 until the end condition is satisfied. Hereinafter, the processing of steps S3 to S7 will be described.

The prediction model learning unit 321 refers to the information stored in the storage unit 4, and for each cluster of the first ID, learns a prediction model having an attribute whose value is unknown in a part of records in the first master data, as an objective variable. Then, the prediction model learning unit 321 stores, in the storage unit 4, each prediction model obtained by learning (step S3).

The cluster assignment unit 322 updates the cluster assignment of each first ID and the cluster assignment of each second ID stored in the storage unit 4 (step S4). In step S4, the cluster assignment unit 322 reads the cluster assignment, the fact data, and the cluster relation stored in the storage unit 4 and newly sets cluster assignment of each first ID and cluster assignment of second ID based on the cluster assignment, the fact data, and the cluster relation.

For each cluster in which the prediction model is generated, the cluster assignment unit 322 calculates a prediction value of an attribute to be an objective variable using a prediction model corresponding to the cluster and calculates a difference (accuracy of the prediction model) between the prediction value and the correct value. The cluster assignment unit 322 corrects the belonging probability of the first ID so that as the difference is smaller, the belonging probability to the first ID belonging to the cluster of interest is increased, and as the difference is larger, the belonging probability to the first ID belonging to the cluster of interest is lowered. The cluster assignment unit 322 does not need to perform this processing for each cluster in which a prediction model is not generated (that is, each cluster of the second ID).

The cluster assignment unit 322 stores the cluster assignment of each first ID after update and the cluster assignment of each second ID in the storage unit 4.

Next, the cluster information calculation unit 323 refers to the assignment of the first master data and the clusters of the respective first IDs, and for each cluster of the first ID, recalculates the model information of the cluster using the value of the attribute corresponding to the first ID belonging to the cluster. Similarly, the cluster information calculation unit 323 refers to the cluster assignment of the second master data and the respective second IDs, and for each cluster of the second ID, recalculates the model information of the cluster using the value of the attribute corresponding to the second ID belonging to the cluster. The cluster information calculation unit 323 updates the model information of the cluster stored in the storage unit 4 with the model information of the newly calculated cluster (step S5).

Next, the cluster relation calculation unit 324 refers to the cluster assignment of each first ID, the cluster assignment of each second ID, and the fact data, and recalculates the cluster relation for each combination of the cluster of the first ID and the cluster of the second ID. The cluster relation calculation unit 324 updates the cluster relation stored in the storage unit 4 with the newly calculated cluster relation (step S6).

Next, the end determination unit 325 determines whether or not the end condition is satisfied (step S7). If the end condition is not satisfied (No in step S7), the end determination unit 325 determines to repeat steps S3 to S7. Then, the clustering unit 32 executes steps S3 to S7 again.

Furthermore, if the end condition is satisfied (Yes in step S7), the end determination unit 325 determines to end the repetition in steps S3 to S7. In this case, the result output unit 5 outputs the result of the processing by the clustering unit 32 at that time, and the processing of the co-clustering system 1 is ended.

According to the present exemplary embodiment, the cluster assignment unit 322 refers to the fact data and performs cluster assignment of the first ID and the second ID. In other words, the cluster assignment unit 322 refers to the fact data and executes co-clustering of the first IDs and the second IDs. Then, the prediction model learning unit 321 generates a prediction model for each cluster. As a result, different prediction models are obtained for each cluster. Further, the fact data represents the relation between the first ID and the second ID. For example, the fact data shows a relation such that the customer 1 has purchased the product 1, but has never purchased the product 2, or the like. Therefore, in the clustering result of the first ID in the present exemplary embodiment, a more appropriate cluster can be obtained as compared with the clustering result obtained by simply clustering the first ID based on the value of the attribute in the first master data. This also applies to the clustering result of the second ID. Since such a prediction model can be obtained individually for each more appropriate cluster, the prediction accuracy of the prediction model for each cluster can be further improved.

Furthermore, in the present exemplary embodiment, the prediction model learning unit 321 adjusts the belonging probability of the ID belonging to the cluster according to the prediction accuracy of the cluster. Accordingly, a more appropriate cluster can be obtained. Therefore, it is possible to further improve the prediction accuracy of the prediction model for each cluster.

Further, in the above description, a case where the value of a specific attribute is unknown in some records in the customer data illustrated in FIG. 1 has been described as an example. In the customer data, the values of each attribute are all determined, and the value of a specific attribute may be unknown in some records in the product data illustrated in FIG. 2. In this case, the co-clustering system 1 may perform the same processing as in the first exemplary embodiment, with the product data as the first master data and the customer data as the second master data.

Furthermore, in each of the first master data and the second master data, the value of the specific attribute may be unknown in some records. In this case, the prediction model learning unit 321 may learn the prediction model for each cluster of the first ID and learn the prediction model for each cluster of the second ID. The cluster assignment unit 322 may also use the accuracy of the prediction model corresponding to the second ID cluster when determining the belonging probability to each cluster also with respect to the second ID.

Apart from the method according to the first exemplary embodiment described above, as a method for generating a prediction model based on the first master data, the second master data, and the fact data, the following method can be considered. Specifically, it is conceivable to integrate the first master data, the second master data, and the fact data, to learn the prediction model based on the integrated data without clustering by adding the second master data and the information indicated by the fact data to each record of the first master data. However, the prediction accuracy of the prediction model obtained by this method is lower than the prediction accuracy of the prediction model obtained in the above-described first exemplary embodiment. This point will be explained concretely.

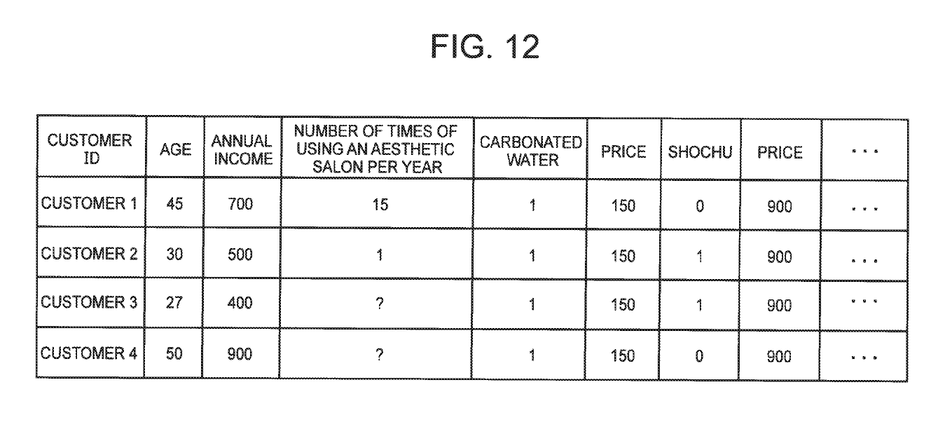

FIG. 12 depicts an explanatory diagram showing an example of a result of integrating the first master data and the second master data shown in FIG. 1 and FIG. 2, and the fact data shown in FIG. 3. “1” or “0” is stored in the column corresponding to the product name such as “carbonated water” and “shochu” based on the fact data (see FIG. 3). “1” means that the customer has purchased the product, and “0” means that the customer has not purchased the product. In addition, in FIG. 12, the case where the price of the product is stored in the column next to the product name such as “carbonated water”, “shochu” or the like is illustrated.

In the integration result shown in FIG. 12, each column other than the customer ID is expressed in a form to be an attribute of the customer ID. This means that some of the information indicated by the master data before the integration is lost. For example, in the example shown in FIG. 12, the price of carbonated water is not an attribute of the customer ID, but is formally expressed as the attribute of the customer ID. Since the price of the carbonated water is treated as an attribute of the customer ID, the information indicated by the second master data (see FIG. 2) before consolidation that the price of “carbonated water” is “150” will be lost.

Therefore, even if a prediction model is generated based on the integration result shown in FIG. 12, the prediction accuracy of the prediction model is lower than the prediction accuracy of the prediction model obtained in the above-described first exemplary embodiment.

### Second Exemplary Embodiment

In the second exemplary embodiment of the present invention, a prediction system that executes co-clustering, generates a prediction model for each cluster of the first ID, and executes prediction by the prediction model will be described.

The first master data, the second master data and the fact data are also input to the prediction system of the second exemplary embodiment of the present invention. The first master data, the second master data and the fact data in the second exemplary embodiment are respectively the same as the first master data, the second master data and the fact data in the first exemplary embodiment.

In the first master data, of the attributes corresponding to the first ID, regarding the specific attribute, the value is unknown in some records.

Further, in the second exemplary embodiment, it is assumed that the values of the respective attributes are all determined in the second master data.

Further, in the second exemplary embodiment, it is assumed that the first ID (the ID of the record of the first master data) is the customer ID, and the first master data represents the correspondence between the customer and the attribute of the customer. It is also assumed that the second ID (the ID of the record of the second master data) is the product ID, and the second master data represents the correspondence relation between a product and the attribute of the product.

Since the customer ID represents a customer, the customer ID may be simply referred to as a customer. Likewise, since the product ID represents a product, the product ID may be simply referred to as a product.

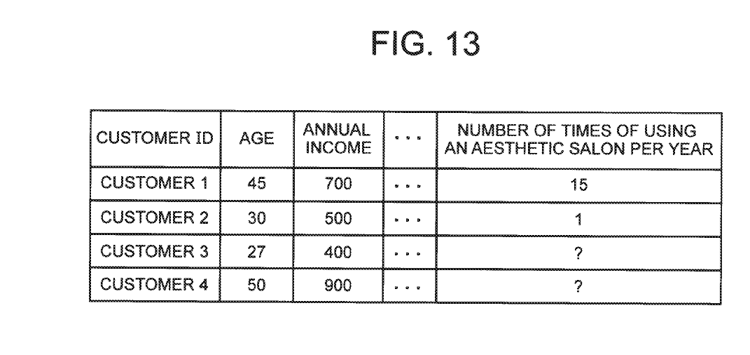

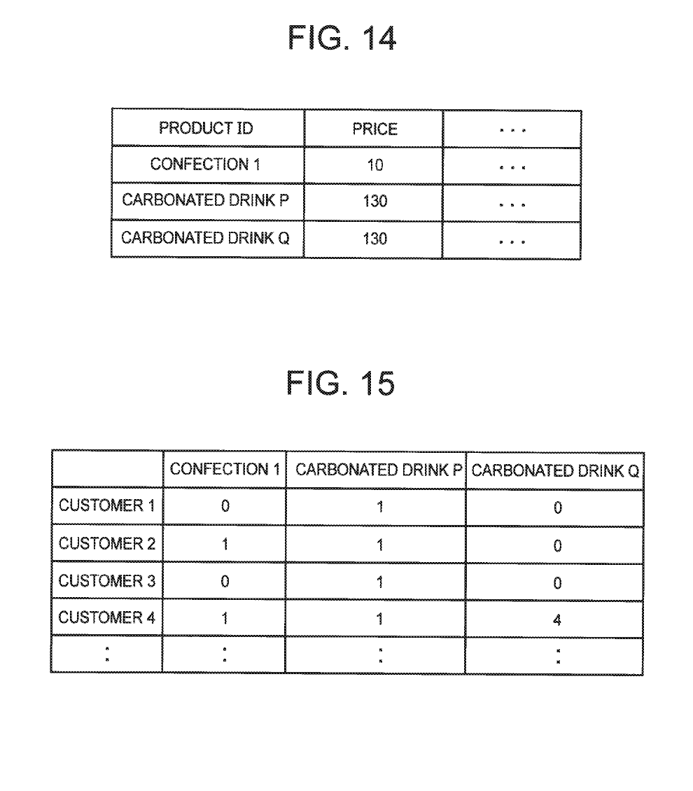

In the second exemplary embodiment, the first master data illustrated in FIG. 13 and the second master data illustrated in FIG. 14 will be described below. In the first master data, attributes other than those shown in FIG. 13 may be indicated. In the second master data, attributes other than those shown in FIG. 14 may be indicated.

The fact data is data indicating the relation between the first ID (customer ID) and the second ID (product ID). In the second exemplary embodiment, it is assumed that the fact data indicates a relation as to whether or not there is a record of purchase of a product by a customer. As in the case shown in FIG. 3, it is assumed that “1” indicates that the customer has purchased the item and “0” indicates that the customer does not purchase the product.

Hereinafter, the second exemplary embodiment will be described with reference to the fact data illustrated in FIG. 15.

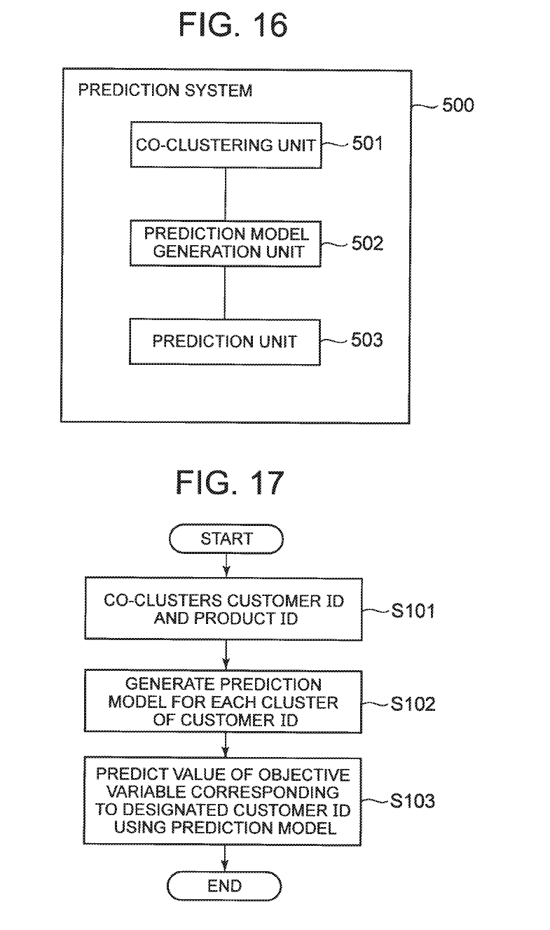

FIG. 16 depicts a functional block diagram showing an example of a prediction system according to the second exemplary embodiment of the present invention. A prediction system 500 according to the second exemplary embodiment of the present invention includes a co-clustering unit 501, a prediction model generation unit 502, and a prediction unit 503.

In the prediction system 500, first master data, second master data and fact data are input.

The co-clustering unit 501 co-clusters the first IDs (customer IDs) and the second IDs (product IDs) based on the first master data, the second master data, and the fact data. It can be said that the co-clustering unit 501 co-clusters the customers and products based on the first master data, the second master data, and the fact data.

A method for co-clustering the customer IDs and the product IDs by the co-clustering unit 501 based on the first master data, the second master data, and the fact data may be a known co-clustering method. In addition, the co-clustering unit 501 may execute soft clustering as a co-clustering or may execute hard clustering.

In the first exemplary embodiment, the processing of repeating the generation of the prediction model and the co-clustering processing (more specifically, the processing of steps S3 to S7 is repeated) is performed until it is determined that the predetermined condition is satisfied; however, in the second exemplary embodiment, a case where such repetition is not performed will be described as an example. Therefore, in the second exemplary embodiment, the prediction model generation unit 502 described later generates a prediction model after completion of co-clustering of the customer ID and the product ID by the co-clustering unit 501.

When the co-clustering unit 501 completes the co-clustering, the prediction model generation unit 502 generates a prediction model for each cluster of the customer IDs.

At this time, the prediction model generation unit 502 generates a prediction model having an attribute in the first master data whose value is unknown in some records as an objective variable. For example, the prediction model generation unit 502 generates a prediction model having “the number of times of using an aesthetic salon per year” shown in FIG. 13 as an objective variable.

Further, the prediction model generation unit 502 generates a prediction model having some or all of the attributes in the first master data having no unknown value as an explanatory variable. For example, the prediction model generation unit 502 generates a prediction model having “age” and “annual income” shown in FIG. 13 as an explanatory variable. For example, the prediction model generation unit 502 may generate a prediction model having only “age” (or “annual income”) as an explanatory variable.

Furthermore, the prediction model generation unit 502 may use, as an explanatory variable, not only the attribute in the first master data but also the aggregate value calculated from the value of the attribute in the second master data. However, when an aggregate value calculated from the value of an attribute in the second master data is used as an explanatory variable, the prediction model generation unit 502 uses the statistical amount of the value of the attribute in each record in the second master data determined to be related to the customer ID by the fact data, as an explanatory variable.

As an example of “the statistic of the value of the attribute in each record in the second master data determined to be related to the customer ID by the fact data”, for example, “maximum value of the prices of the products purchased by the customer”, “average value of the prices of the products purchased by the customer”, and the like can be mentioned, but the present invention is not limited thereto. In the above example, the “product purchased by the customer” corresponds to the record in the second master data which is determined to be related to the customer ID by the fact data. The prediction model generation unit 502 may use the statistical amount (for example, maximum value, average value, and the like) of the price in such a record, as an explanatory variable. Hereinafter, an explanation will be given by taking as an example a case where “maximum value of the prices of the products purchased by the customer” is used as an explanatory variable.

Focusing on the customer ID that can specify a value of an explanatory variable and a value of an objective variable, the prediction model generation unit 502 may generate a prediction model by specifying the value of the explanatory variable and the value of the objective variable and executing machine learning using these values as teacher data. The prediction model generation unit 502 may perform this processing for each cluster.

For example, since the value of the objective variable (the number of times of using an aesthetic salon per year) corresponding to “customer 3” shown in FIG. 13 is unknown, the record of “customer 3” cannot be used as teacher data.

Meanwhile, regarding “customer 1” and “customer 2” shown in FIG. 13, an explanatory variable and an objective variable can be specified. For example, values such as “age”, “annual income”, and the like of “customer 1” and “customer 2” and “the number of times of using an aesthetic salon per year” can be specified from the first master data. Furthermore, according to the fact data (see FIG. 15), the prediction model generation unit 502 determines that the product purchased by “customer 1” is only “carbonated drink P”, thereby specifying “130” as the attribute statistic in the record of “carbonated drink P” of the second master table. That is, by referring to the fact data, the prediction model generation unit 502 can specify the maximum value of the prices of the products purchased by the customer 1. Similarly, according to the fact data (see FIG. 15), the prediction model generation unit 502 determines that the products purchased by “customer 2” are “confection 1” and “carbonated drink P”, thereby specifying “130” as the attribute statistic in the record of “sweets 1” and the record of “carbonated drink P” of the second master table. That is, by referring to the fact data, the prediction model generation unit 502 can specify the maximum value among the prices of the products purchased by the customer 2. Therefore, data on “customer 1” and “customer 2” can be used as teacher data.

When the co-clustering unit 501 executes soft clustering, the value of the teacher data may be weighted according to the belonging probability that the customer ID belongs to each cluster.

The prediction unit 503 accepts designation of the customer ID and the objective variable (in the exemplary embodiment, “the number of times of using an aesthetic salon per year”) from the user of the prediction system 500, for example. Then, the prediction unit 503 predicts the value of an objective variable corresponding to the designated customer ID by using the prediction model generated by prediction model generation means 502.

When the co-clustering unit 501 executes hard clustering, the prediction unit 503 specifies the cluster to which the specified customer ID belongs and predicts the value of an objective variable corresponding to the customer ID by using a prediction model corresponding to the specified cluster.

At this time, the prediction unit 503 identifies the value of the explanatory variable for the designated customer ID, and may calculate the prediction value by applying the value of the explanatory variable to the prediction model corresponding to the cluster to which the designated customer ID belongs. For example, it is assumed that explanatory variables are “age” and “maximum value of prices of products purchased by customers”. Further, it is assumed that “customer 4” shown in FIG. 13 is designated. The prediction unit 503 specifies the age “50” of “customer 4” from the first master data. Further, according to the fact data (see FIG. 15), the prediction unit 503 determines that the products purchased by “customer 4” are “confection 1”, “carbonated drink P” and “carbonated drink Q”, and calculates the maximum price “130” of “confection 1”, “carbonated drink P” and “carbonated drink Q”, from the second master data (see FIG. 14). Then, the prediction unit 503 may apply the values “50” and “130” of each explanatory variable to a prediction model corresponding to the cluster to which “customer 4” belongs.

Furthermore, when the co-clustering unit 501 executes soft clustering, the prediction unit 503 predicts a value of an objective variable corresponding to the designated customer ID for each prediction model corresponding to each cluster of the customer ID. The operation of predicting the value of the objective variable focusing on one prediction model is the same as the above operation, and the explanation is omitted.

After obtaining the prediction value for each prediction model corresponding to each cluster, the prediction unit 503 weights and adds each of the prediction values with the belonging probability that the designated customer ID belongs to each cluster and fixes the result as the value of the objective variable.

The co-clustering unit 501, the prediction model generation unit 502, and the prediction unit 503 are realized, for example, by a CPU of a computer operating according to a program (prediction program). In this case, the CPU reads the program from a program recording medium such as a program storage device (not shown in FIG. 16) of the computer, for example, and in accordance with the program, the CPU may operate as the co-clustering unit 501, the prediction model generation unit 502, and the prediction unit 503. Further, the co-clustering unit 501, the prediction model generation unit 502, and the prediction unit 503 may be realized by dedicated hardware.

Next, the processing progress of the second exemplary embodiment will be described. FIG. 17 is a flowchart showing an example of the processing progress of the second exemplary embodiment.

When the first master data, the second master data, and the fact data are input to the prediction system 500, the co-clustering unit 501 co-clusters the customer IDs and the product IDs based on the first master data, the second master data, and the fact data (step S101). The co-clustering method in step S101 may be a known co-clustering method. The co-clustering unit 501 outputs each cluster obtained as a result of the co-clustering to the prediction model generation unit 502.

When the co-clustering of the customer ID and the product ID is completed, the prediction model generation unit 502 generates a prediction model for each cluster of the customer ID output by the co-clustering unit 501 (step S102). The details of the operation of the prediction model generation unit 502 have already been described, so that the description thereof will be omitted here.

After step S102, upon receiving the customer ID and designation of the objective variable, the prediction unit 503 predicts a value of an objective variable corresponding to the designated customer ID by using the prediction model generated in step S102 (step S103). The details of the operation of the prediction unit 503 have already been described, so that the description thereof will be omitted here.

According to the second exemplary embodiment, the co-clustering unit 501 co-clusters the customer IDs (first IDs) and the product IDs (second IDs) based on the first master data, the second master data, and the fact data. Therefore, the clustering accuracy of each of the customer ID and the product ID is improved as compared with the case where the customer ID is clustered based on only the first master data or the case where the product ID is clustered based only on the second master data.

For each cluster of customer IDs clustered with such good accuracy, the prediction model generation unit 502 generates a prediction model. Therefore, the accuracy of the prediction model is also good, and the accuracy of the prediction value of the objective variable obtained based on the prediction model also increases. That is, according to the prediction system of the second exemplary embodiment, prediction can be performed with high accuracy.

The prediction model generation unit 502 may use statistics of the values of not only the attribute of the first master data but also the attributes in each record in the second master data determined to be related to the customer ID by the fact data, as explanatory variables of the predictive model. By using such statistics as explanatory variables, the accuracy of the prediction model can be further improved, and as a result, the accuracy of the prediction value obtained based on the prediction model is further improved.

### Third Exemplary Embodiment

In the second exemplary embodiment, unlike the first exemplary embodiment, a system that generates a prediction model after co-clustering is completed without repeating generation of a prediction model and co-clustering processing.

As in the first exemplary embodiment, the co-clustering system according to the third exemplary embodiment of the present invention co-clusters the first IDs and the second IDs by repeating the processing of steps S3 to S7, and generates a prediction model corresponding to a cluster. Furthermore, the co-clustering system according to the third exemplary embodiment of the present invention predicts the value of an objective variable when test data is input.

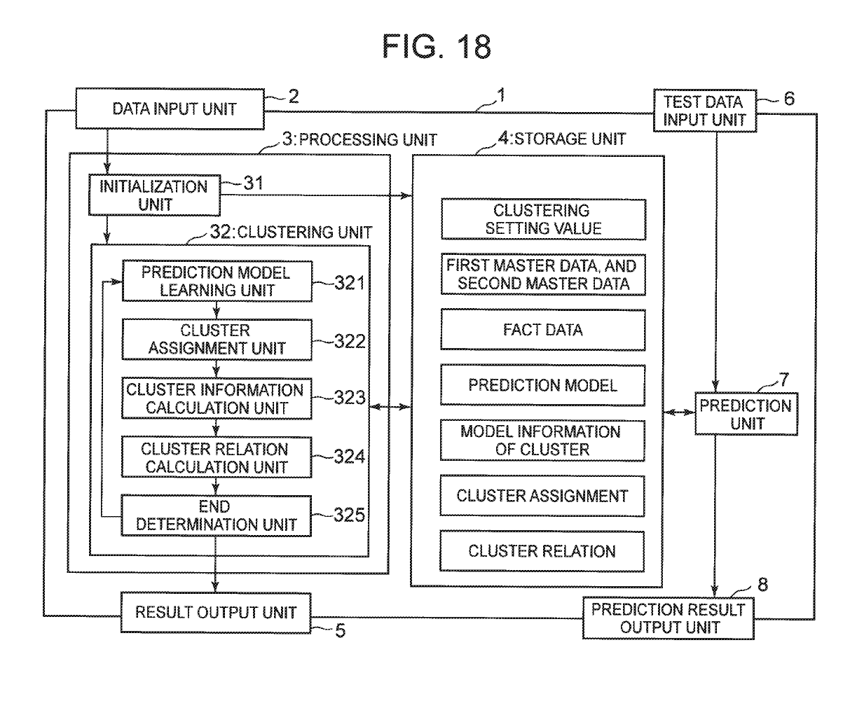

FIG. 18 depicts a functional block diagram showing an example of a co-clustering system according to the third exemplary embodiment of the present invention. Elements similar to those in the first exemplary embodiment are denoted by the same reference numerals as those in FIG. 6, and description thereof is omitted. The co-clustering system 1 of the third exemplary embodiment includes a test data input unit 6, a prediction unit 7, and a prediction result output unit 8 in addition to the data input unit 2, the processing unit 3, the storage unit 4, and the result output unit 5.

In the following description, it is assumed that the processing unit 3 completes the processing described in the first exemplary embodiment, classifies the first ID and the second ID into clusters, and a prediction model is generated for each cluster of the first ID.

The test data input unit 6 acquires the test data. For example, the test data input unit 6 may access an external device to acquire test data. Alternatively, the test data input unit 6 may be an input interface to which test data is input.

The test data includes a record of a new first ID whose objective variable (for example, “the number of times of using an aesthetic salon per year” in the first master data shown in FIG. 1) is unknown and data indicating a relation between the new first ID and the second ID in the second master data.

The new record of the first ID is, for example, a record of a member who has been just registered as a member in a certain service. In this record, it is assumed that values of attributes (for example, “age”, “annual income”, and the like) other than an attribute corresponding to the objective variable are determined.

Further, as an example of data indicating the relation between the new first ID and the second ID in the second master data, the product purchase history data of the customer specified by the new first ID can be mentioned. The data indicating the relation between the new first ID and the second ID in the second master data can also be said to be fact data related to the new first ID.

The prediction unit 7 specifies a cluster to which the new first ID included in the test data belongs. At this time, the prediction unit 7 may specify the cluster based on the value of the attribute included in the new record of the first ID. For example, by comparing the value of the attribute included in the record of the new first ID (for example, the value of “age”, “annual income”) with the value of the attribute in the record of each first ID belonging to each cluster, the prediction unit 7 may specify a cluster in which the value of the attribute of each belonging first ID is closest to the value of the attribute included in the record of the new first ID. The prediction unit 7 may regard the cluster as a cluster to which the new first ID belongs.

Furthermore, the prediction unit 7 may specify the product purchasing tendency of the customer specified by the new first ID and specify the first ID cluster having a similar product purchasing tendency based on data (for example, product purchase history data) indicating the relation between the new first ID and the second ID in the second master data. The prediction unit 7 may regard the cluster as a cluster to which the new first ID belongs.

After specifying the cluster to which the first ID belongs, the prediction unit 7 applies the value of the attribute included in the record of the new first ID to a prediction model corresponding to the cluster, thereby predicting the value of an objective variable corresponding to the new first ID.

In the above description, the case where the prediction unit 7 specifies the cluster to which the new first ID belongs has been described. The prediction unit 7 may calculate a belonging probability that the new first ID belongs to the cluster for each cluster of the first ID. For example, the prediction unit 7 may calculate a belonging probability to each cluster of the new first ID in accordance with the degree of proximity between the value of the attribute of each first ID belonging to the cluster and the value of the attribute included in the record of the new first ID for each cluster by comparing the value of the attribute included in the record of the new first ID (for example, the value of “age”, “annual income”) with the value of the attribute in the record of each first ID belonging to each cluster.

Furthermore, the prediction unit 7 may specify the product purchasing tendency of the customer specified by the new first ID and calculates a belonging probability to each cluster of the new first ID in accordance with the degree of proximity between the product purchasing tendency and the product purchasing tendency of each cluster of the first ID based on data (for example, product purchase history data) indicating the relation between the new first ID and the second ID in the second master data.

When calculating the belonging probability to each cluster of the new first ID, the prediction unit 7 applies the value of the attribute included in the record of the new first ID for each prediction model corresponding to each cluster of the first ID and predicts the value of the objective variable. Further, after obtaining the prediction value for each prediction model corresponding to each cluster, the prediction unit 7 may weight and add each of the prediction values with the belonging probability to each cluster of the new first ID and fix the result as the value of the objective variable.

The prediction result output unit 8 outputs the value of the objective variable predicted by the prediction unit 7. A manner in which the prediction result output unit 8 outputs the prediction value of the objective variable is not particularly limited. For example, the prediction result output unit 8 may output the prediction value of the objective variable to another device. Further, for example, the prediction result output unit 8 may cause the display device to display the prediction value of the objective variable.

The test data input unit 6, the prediction unit 7, and the prediction result output unit 8 are also realized, for example, by a CPU of a computer operating according to a program (co-clustering program).

According to the present exemplary embodiment, an unknown value in a given test data can be predicted.

### Specific Example

A specific example of the first exemplary embodiment will be described below. In the following specific example, the master data may be referred to as a data set in some cases. Further, the first master data may be referred to as “data set 1”, and the second master data may be referred to as “data set 2”. The fact data may be referred to as relational data in some cases.

The meanings of symbols and the like used in mathematical formulas shown in the following specific examples are summarized in the following tables.

TABLE 1

| Symbol | Explanation |
|---|---|
| ψ | Digamma function |
| D⁽¹⁾ | Total number of data in data set 1 |
| D⁽²⁾ | Total number of data in data set 2 |
| d₁ | Index indicating d₁-th data in data set 1 |
| d₂ | Index indicating d₂-th data in data set 2 |
| K⁽¹⁾ | Total number of clusters in data set 1 |
| K⁽²⁾ | Total number of clusters in data set 2 |
| k₁ | Index indicating k₁-th cluster in data set 1 |
| k₂ | Index indicating k₂-th cluster in data set 2 |
| q(z_{d}_{₁}⁽¹⁾ = k₁) = ϕ_{d}_{₁}_{, k}_{₁}⁽¹⁾ | Belonging probability that data d₁ in data |
| | set 1 corresponds to cluster k₁ |
| q(z_{d}_{₂}⁽²⁾ = k₂) = ϕ_{d}_{₂}_{, k}_{₂}⁽²⁾ | Belonging probability that data d₂ in data |
| | set 2 corresponds to cluster k₂ |

TABLE 2

| | |
|---|---|
| \hat{α}ₖ_{₁}⁽¹⁾, \hat{β}ₖ_{₁}⁽¹⁾ | Parameters used to calculate a belonging probability to cluster k₁ |
| | of data set 1 (a probability that cluster k₁ is selected is adjusted |
| | to be higher as \hat{α}ₖ_{₁}⁽¹⁾ is larger and to be lower as βₖ_{₁}⁽¹⁾ is larger) |
| \hat{α}ₖ_{₂}⁽²⁾, \hat{β}ₖ_{₂}⁽²⁾ | Parameters used to calculate a belonging probability to cluster k₂ |
| | of data set 2 (a probability that cluster k₂ is selected is adjusted |
| | to be higher as \hat{α}ₖ_{₂}⁽²⁾ is larger and to be lower as βₖ_{₂}⁽²⁾ is larger) |
| α⁽¹⁾ | Hyper parameter that controls the number of clusters in data set 1. |
| | As this value is larger, the number of clusters tends to increase |
| α⁽²⁾ | Hyper parameter that controls the number of clusters in data set 2. |
| | As this value is larger, the number of clusters tends to increase |
| x_{d}_{₁}_{d}_{₂} | Relational data indicating whether data d₁ of data set 1 is related |
| | to d₂-th data of a second data set (when x_{d}_{₁}_{d}_{₂} = 1, there is a |
| | relation, and when 0, there is no relation) |
| âₖ_{₁} ₖ_{₂}^{[1]}, \hat{b}ₖ_{₁} ₖ_{₂}^{[1]} | Parameters used to calculate the strength of a relation between |
| | cluster k₁ of data set 1 and cluster k₂ of data set 2 (as âₖ_{₁} ₖ_{₂}^{[1]} is |
| | larger, the relation is stronger, and as bₖ_{₁} ₖ_{₂}^{[1]} is larger, the relation |
| | is smaller) |
| a₀^{[1]}, b₀^{[1]} | Hyper parameters used for calculation of aₖ_{₁} ₖ_{₂}^{[1]}, bₖ_{₁} ₖ_{₂}^{[1]}. |
| | When a₀^{[1]} > b₀^{[1]}, a relation between clusters tends to be strong |
| ρ | It is a value between 0 and 1, and as this value approaches 0, the |
| | effect of supervised learning in determining a cluster belonging |
| | probability ϕ_{d}_{₁}_{, k}_{₁}⁽¹⁾ becomes stronger |
| y₁ | A value of a prediction target attribute of data set 1 (example: “male”) |
| Y⁽¹⁾ | Number of types of values of prediction target attribute of data set 1 |
| | (example: if an attribute value is either “male” to “female”, the |
| | number is 2) |
| ω_{y}_{_{1,}}_{d}_{₁}⁽¹⁾ | Strength of the influence of data d₁ of data set 1 on learning of the |
| | prediction model |
| [symbol] | Attribute prediction model of data set 1 (separation plane of SVM) |
| f_{d}_{₁}^{Δ}(y₁) | Generation function of input for prediction score calculation |
| [symbol] | A prediction score when predicting an attribute of data d₁ of data |
| | set 1 by a SVM model of a cluster k₁ (as the prediction score is larger, |
| | the prediction error is smaller) |

In the following specific example, an inference algorithm based on the variational Bayes method when infinite mixed Bayes model is used is described. Further, similarly to the case exemplified in the first exemplary embodiment and the like, it is assumed that the first master data (data set 1) is master data on a customer and the second master data (data set 2) is master data on a product. Furthermore, it is assumed that there is an attribute whose values are unknown in some records in the first master data.

The probability that the d₁₋th customer (customer ID) belongs to the cluster k₁ is expressed by a following expression (1).

$$\begin{matrix}[ Expression 5 ] & \\ log q ( {z}_{{d}_{1}}^{( 1 )} = {k}_{1} ) = log {φ}_{{d}_{1} , {k}_{1}}^{( 1 )} ∝ ψ ( {\hat{α}}_{{k}_{1}}^{( 1 )} ) - ψ ( {\hat{α}}_{{k}_{1}}^{( 1 )} + {\hat{β}}_{{k}_{1}}^{( 1 )} ) + {\sum }_{{k}_{1}^{′} = {k}_{1} + 1}^{{K}^{( 1 )}} \{ ψ ( {\hat{β}}_{{k}_{{1}^{′}}}^{( 1 )} ) - ψ ( {α}_{{k}_{{1}^{′}}}^{( 1 )} + {\hat{β}}_{{k}_{{1}^{′}}}^{( 1 )} ) \} + ρ {\sum }_{{d}_{2}}^{{D}^{( 2 )}} {\sum }_{{k}_{2}}^{{K}^{( 2 )}} {φ}_{{d}_{2} , {k}_{2}}^{( 2 )} \{ ψ ( {\hat{a}}_{{k}_{1} {k}_{2}}^{[ 1 ]} + {\hat{b}}_{{k}_{1} {k}_{2}}^{[ 1 ]} ) + {x}_{{d}_{1} {d}_{2}} ψ ( {\hat{a}}_{{k}_{1} {k}_{2}}^{[ 1 ]} ) + ( 1 - {x}_{{d}_{1} {d}_{2}} ) ψ ( {\hat{a}}_{{k}_{1} {k}_{2}}^{[ 1 ]} ) \} + ( 1 - ρ ) \{ {\sum }_{{y}_{1}}^{{Y}^{( 1 )}} {ω}_{{y}_{1} , {d}_{1}}^{( 1 )} {{𝔼}_{q ( {η}_{{k}_{1}}^{( 1 )} )} [ {η}_{{k}_{1}}^{( 1 )} ]}^{T} {f}_{{d}_{1}}^{Δ} ( {y}_{1} ) \} & ( 1 )\end{matrix}$$

A probability that the d₂₋th product (product ID) belongs to the cluster k₂ is expressed by a following expression (2).

$$\begin{matrix}[ Expression 6 ] & \\ log q ( {z}_{{d}_{2}}^{( 1 )} = {k}_{2} ) = log {φ}_{{d}_{2} , {k}_{2}}^{( 2 )} ∝ ψ ( {\hat{α}}_{{k}_{2}}^{( 2 )} ) - ψ ( {\hat{α}}_{{k}_{2}}^{( 2 )} + {\hat{β}}_{{k}_{2}}^{( 2 )} ) + {\sum }_{{k}_{2}^{′} = {k}_{2} + 1}^{{K}^{( 2 )}} \{ ψ ( {\hat{β}}_{{k}_{{2}^{′}}}^{( 2 )} ) - ψ ( {α}_{{k}_{{2}^{′}}}^{( 2 )} + {\hat{β}}_{{k}_{{2}^{′}}}^{( 2 )} ) \} + {\sum }_{{d}_{1}}^{{D}^{( 1 )}} {\sum }_{{k}_{1}}^{{K}^{( 1 )}} {φ}_{{d}_{1} , {k}_{1}}^{( 1 )} \{ ψ ( {\hat{a}}_{{k}_{1} {k}_{2}}^{[ 1 ]} + {\hat{b}}_{{k}_{1} {k}_{2}}^{[ 1 ]} ) + {x}_{{d}_{1} {d}_{2}} ψ ( {\hat{a}}_{{k}_{1} {k}_{2}}^{[ 1 ]} ) + ( 1 - {x}_{{d}_{1} {d}_{2}} ) ψ ( {\hat{a}}_{{k}_{1} {k}_{2}}^{[ 1 ]} ) \} & ( 2 )\end{matrix}$$

Note that Ψ is a Digamma function. ρ is a parameter that can be set by a system administrator, and ρ is set to a value within the range of 0 to 1. As the value of ρ approaches 0, the effect of learning in co-clustering is stronger. That is, the belonging probability to the cluster of IDs is easily determined so that the accuracy of the prediction model is improved.

The following part in the expression (1) represents a score when the attribute value of the d₁-th customer is predicted by the prediction model of the cluster k₁. As the prediction error is smaller, the score increases. In other words, as the prediction error is smaller, the probability that the d₁-th customer belongs to the cluster k₁ increases.

$$\begin{matrix}[ Expression 7 ] & \\ {\sum }_{{y}_{1}}^{{Y}^{( 1 )}} {ω}_{{y}_{1} , {d}_{1}}^{( 1 )} {{𝔼}_{q ( {η}_{{k}_{1}}^{( 1 )} )} [ {η}_{{k}_{1}}^{( 1 )} ]}^{T} {f}_{{d}_{1}}^{Δ} ( {y}_{1} ) & \end{matrix}$$

Furthermore, the generation model of a hidden variable of the data set 1 is expressed by a following expression (3).

[Expression 8]

z_{d}_{₁}⁽¹⁾˜Mult(ϕ_{d}_{₁}⁽¹⁾) (3)

Furthermore, a variational posterior distribution of the parameter is expressed by a following expression (4).

[Expression 9]

q(υₖ_{₁}⁽¹⁾)=Beta(\hat{α}ₖ_{₁}⁽¹⁾,\hat{β}ₖ_{₁}⁽¹⁾) (4)

Furthermore, the update formula of the parameter is expressed by following expressions (5) and (6).

$$\begin{matrix}[ Expression 10 ] & \\ {\hat{α}}_{{k}_{1}}^{( 1 )} = 1 + {\sum }_{{d}_{1}}^{{D}^{( 1 )}} {φ}_{{d}_{1} , {k}_{1}}^{( 1 )} & ( 5 ) \\ [ Expression 11 ] & \\ {\hat{β}}_{{k}_{1}}^{( 1 )} = {α}^{( 1 )} + {\sum }_{{d}_{1}}^{{D}^{( 1 )}} {\sum }_{{k}_{1}^{′} = {k}_{1} + 1}^{{K}^{( 1 )}} {φ}_{{d}_{1} , {k}_{1}^{′}}^{( 1 )} & ( 6 )\end{matrix}$$

In addition, the update formula of the parameter relating to the data set 2 is expressed by following expressions (7) and (8).

$$\begin{matrix}[ Expression 12 ] & \\ {\hat{α}}_{{k}_{2}}^{( 2 )} = 1 + {\sum }_{{d}_{2}}^{{D}^{( 2 )}} {φ}_{{d}_{2} , {k}_{2}}^{( 2 )} & ( 7 ) \\ [ Expression 13 ] & \\ {\hat{β}}_{{k}_{2}}^{( 2 )} = {α}^{( 2 )} + {\sum }_{{d}_{2}}^{{D}^{( 2 )}} {\sum }_{{k}_{2}^{′} = {k}_{2} + 1}^{{K}^{( 2 )}} {φ}_{{d}_{2} , {k}_{2}^{′}}^{( 2 )} & ( 8 )\end{matrix}$$

Furthermore, a fact data generation model is expressed by a following expression (9).

[Expression 14]

x_{d}_{₁}_{d}_{₂}˜Bern(θₖ_{₁}ₖ_{₂}^{[1]}) (9)

Furthermore, the variational posterior distribution of the parameter is expressed by a following expression (10).

[Expression 15]

q(θₖ_{₁}ₖ_{₂}^{[1]})=Beta(âₖ_{₁}ₖ_{₂}^{[1]},\hat{b}ₖ_{₁}ₖ_{₂}^{[1]}) (10)

Furthermore, the update formula of the parameter is expressed by following expressions (11) and (12).

$$\begin{matrix}[ Expression 16 ] & \\ {\hat{a}}_{{k}_{1} {k}_{2}}^{[ 1 ]} = {a}_{0}^{[ 1 ]} + {\sum }_{{d}_{1}}^{{D}^{( 1 )}} {\sum }_{{d}_{2}}^{{D}^{( 2 )}} {φ}_{{d}_{1} , {k}_{1}}^{( 1 )} {φ}_{{d}_{2} , {k}_{2}}^{( 2 )} {x}_{{d}_{1} {d}_{2}} & ( 11 ) \\ [ Expression 17 ] & \\ {\hat{b}}_{{k}_{1} {k}_{2}}^{[ 1 ]} = {b}_{0}^{[ 1 ]} + {\sum }_{{d}_{1}}^{{D}^{( 1 )}} {\sum }_{{d}_{2}}^{{D}^{( 2 )}} {φ}_{{d}_{1} , {k}_{1}}^{( 1 )} {φ}_{{d}_{2} , {k}_{2}}^{( 2 )} ( 1 - {x}_{{d}_{1} {d}_{2}} ) & ( 12 )\end{matrix}$$

Furthermore, the posterior distribution of variance of the weight parameter of support vector machine (SVM) is expressed by a following expression (13).

[Expression 18]

q(ηₖ_{₁}⁽¹⁾)=N(\hat{μ}ₖ_{₁}_{⁽¹⁾},I) (13)

Furthermore, the update formula of the parameter is expressed by a following expression (14).

[Expression 19]

$${\hat{μ}}_{{k}_{1}^{( 1 )}} = {w}_{0}^{( 1 )} + {\sum }_{{d}_{1}}^{{D}^{( 1 )}} {φ}_{{d}_{1} , {k}_{1}}^{( 1 )} {\sum }_{{y}_{1}}^{{Y}^{( 1 )}} {ω}_{{y}_{1} , {d}_{1}}^{( 1 )} {f}_{{d}_{1}}^{Δ} ( {y}_{1} ) \qquad ( 14 )$$

Furthermore, the learning problem of the SVM is expressed by a following expression (15).

$$\begin{matrix}[ Expression 20 ] & \\ \begin{matrix}{max}_{{ω}^{( 1 )}} & - \frac{1}{2} {\sum }_{{k}_{1}}^{{K}^{( 1 )}} {\hat{μ}}_{{k}_{1}^{( 1 )}}^{T} {\hat{μ}}_{{k}_{1}^{( 1 )}} + {\sum }_{{y}_{1}}^{{Y}^{( 1 )}} {\sum }_{{d}_{1}}^{{D}^{( 1 )}} {ω}_{{y}_{1} , {d}_{1}}^{( 1 )} {l}_{{d}_{1}}^{Δ} ( {y}^{( 1 )} )\end{matrix} \\ \begin{matrix}s . t . & 0 \leq {\sum }_{{y}_{1}}^{{Y}^{( 1 )}} {ω}_{{y}_{1} , {d}_{1}}^{( 1 )} \leq {C}_{1}^{( 1 )}\end{matrix} & ( 15 )\end{matrix}$$

In the expression (15), μₖ_{₁}⁽¹⁾ is expressed by a following expression (16).

$$\begin{matrix}[ Expression 21 ] & \\ {\hat{μ}}_{{k}_{1}^{( 1 )}} = {w}_{0}^{( 1 )} + {\sum }_{{d}_{1}}^{{D}^{( 1 )}} {φ}_{{d}_{1} , {k}_{1}}^{( 1 )} {\sum }_{{y}_{1}}^{{Y}^{( 1 )}} {ω}_{{y}_{1} , {d}_{1}}^{( 1 )} {f}_{{d}_{1}}^{Δ} ( {y}_{1} ) & ( 16 )\end{matrix}$$

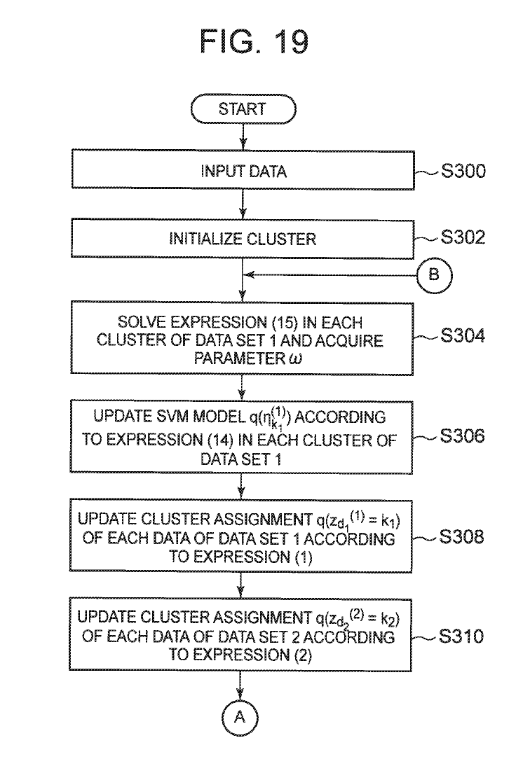

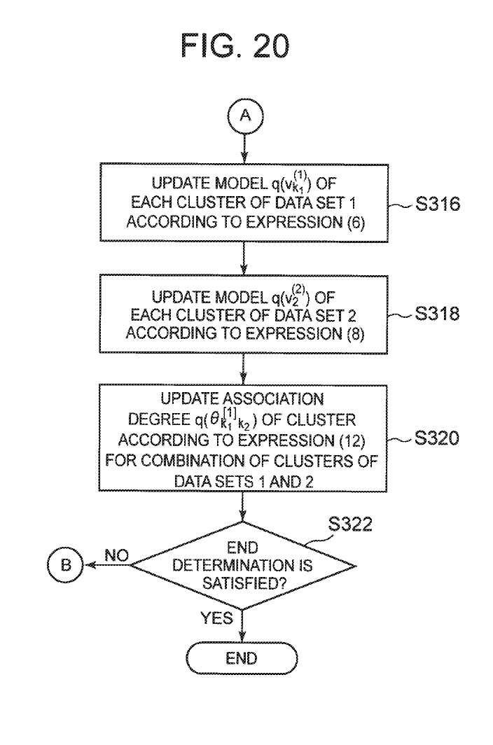

Hereinafter, as a specific example of the first exemplary embodiment, an example of processing progress using the above expression will be described. FIG. 19 and FIG. 20 each depict a flowchart showing an example of processing progress in a specific example of the first exemplary embodiment.

First, the data input unit 2 acquires data (step S300).

Next, the initialization unit 31 initializes the cluster (step S302).

Next, the prediction model learning unit 321 solves expression (15) in each cluster of data set 1 and acquires parameter ω (step S304).

Next, the prediction model learning unit 321 updates a SVM model q(ηₖ₁⁽¹⁾) according to the expression (14) in each cluster of the data set 1 (step S306).

Next, the cluster assignment unit 322 updates the cluster assignment q(z_{d1}⁽¹⁾=k₁) of each data of the data set 1 according to the expression (1) (step S308).

Next, the cluster assignment unit 322 updates the cluster assignment q(z_{d2}⁽²⁾=k₂) of each data of the data set 2 according to the expression (2) (step S310).

Next, the cluster information calculation unit 323 updates the model q(vₖ₁⁽¹⁾) of each cluster of the data set 1 according to the expression (6) (step S316).

Next, the cluster information calculation unit 323 updates the model q(vₖ₂⁽²⁾) of each cluster of the data set 2 according to the expression (8) (step S318).

Next, the cluster relation calculation unit 324 updates an association degree q(θₖ₁ₖ₂^{[1]}) of the cluster according to the expression (12) for the combination of the clusters of the data sets 1 and 2 (step S320).

Next, the end determination unit 325 determines whether or not an end condition is satisfied (step S322). When it is determined that the end condition is not satisfied (No in step S322), the rastering unit 32 repeats the processing in and after step S304.

When it is determined that the end condition is satisfied (Yes in step S322), the result output unit 5 outputs the result of the processing by the clustering unit 32 at that time, and ends the processing.

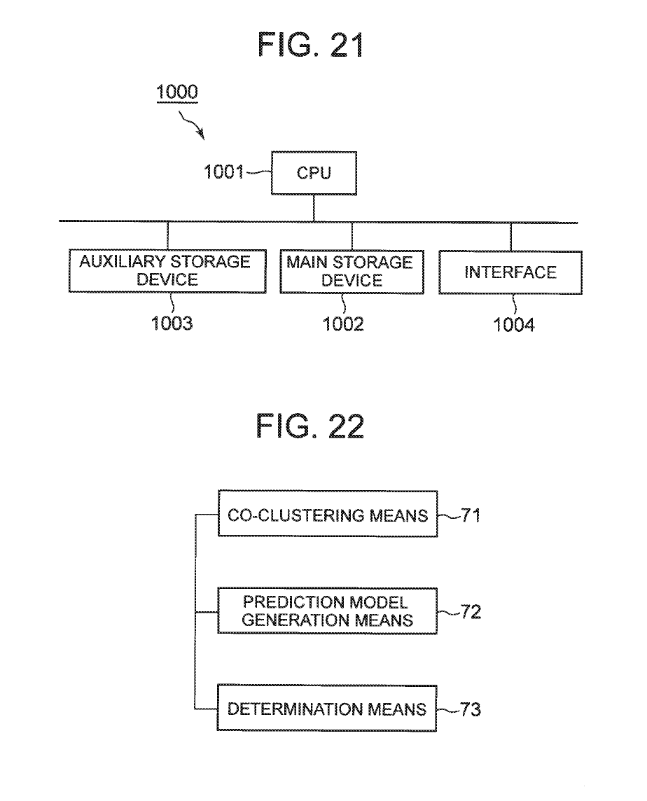

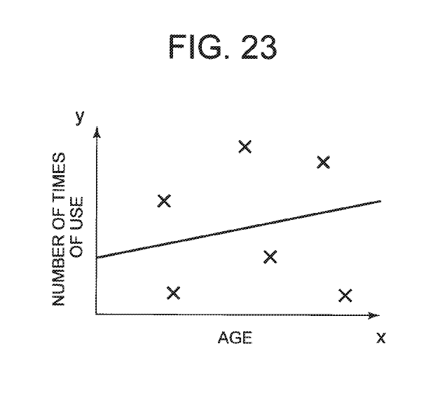

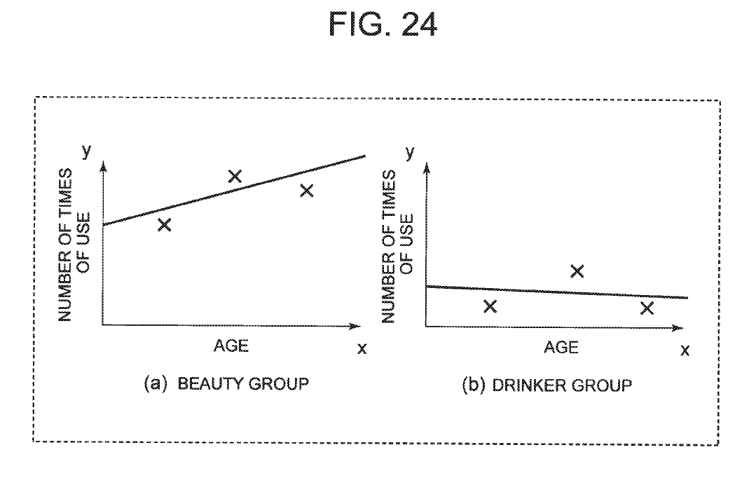

FIG. 21 depicts a schematic block diagram showing a configuration example of a computer according to each exemplary embodiment of the present invention. A computer 1000 includes a CPU 1001, a main storage device 1002, an auxiliary storage device 1003, and an interface 1004.

The system of each exemplary embodiment (the co-clustering system in the first and third exemplary embodiments, and the prediction system in the second exemplary embodiment) is installed in the computer 1000. The operation of the system of each exemplary embodiment is stored in the auxiliary storage device 1003 in the form of a program. The CPU 1001 reads the program from the auxiliary storage device 1003, develops the program in the main storage device 1002, and executes the above processing according to the program.

The auxiliary storage device 1003 is an example of a non-transitory tangible medium. Other examples of non-transitory tangible medium include magnetic disks, magneto-optical disks, CD-ROMs, DVD-ROMs, semiconductor memories, and the like connected via the interface 1004. Furthermore, when this program is delivered to the computer 1000 through a communication line, the distributed computer 1000 may expand the program in the main storage device 1002 and execute the above processing.

Furthermore, the program may be for realizing a part of the above-described processing. Furthermore, the program may be a differential program that realizes the above-described processing in combination with another program already stored in the auxiliary storage device 1003.

In addition, a part or all of each component of each device may be realized by a general purpose or dedicated circuitry, a processor, or the like, or a combination thereof. These may be constituted by a single chip or may be constituted by a plurality of chips connected via a bus. Part or all of the respective constituent elements of each device may be realized by a combination of the above-described circuits and the like with a program.

In the case where a part or the whole of each component of each device is realized by a plurality of information processing devices, circuits, or the like, the information processing devices, circuits, and the like may be arranged in a centralized manner or in a distributed manner. For example, an information processing device, a circuit, or the like may be realized as a form in which each of a client and server system, a cloud computing system, and the like is connected via a communication network.

Next, an outline of the present invention will be described. FIG. 22 depicts a block diagram showing the outline of a co-clustering system of the present invention. The co-clustering system of the present invention includes co-clustering means 71, prediction model generation means 72, and determination means 73.

Based on first master data, second master data, and fact data indicating a relation between a first ID which is an ID of a record in the first master data and a second ID which is an ID of a record in the second master data, the co-clustering means 71 (for example, the cluster assignment unit 322) executes co-clustering processing of co-clustering first IDs and second IDs.

The prediction model generation means 72 (for example, the prediction model learning unit 321) executes prediction model generation processing of generating a prediction model for each cluster of at least the first ID.

The determination means 73 (for example, the end determination unit 325) determines whether or not a predetermined condition is satisfied.

The co-clustering system repeats the prediction model generation processing and the co-clustering processing until it is determined that the predetermined condition is satisfied.

When the co-clustering means 71 determines a belonging probability that one first ID belongs to one cluster, the value of an objective variable corresponding to the first ID is predicted using a prediction model corresponding to the cluster and as a difference between the value and the actual value is smaller, the belonging probability becomes higher.

With such a configuration, it is possible to further improve the prediction accuracy of the prediction model for each cluster.

In addition, when test data including a record of a new first ID whose objective variable is unknown and data indicating a relation between the new first ID and a second ID in the second master data is given, a configuration including prediction means (for example, the prediction unit 7 shown in FIG. 18) that predicts a value of the objective variable may be adopted.

The predicting means may be configured to specify a cluster to which the new first ID belongs by using the value of the attribute included in the record of the new first ID or the data indicating a relation between the new first ID and the second ID in the second master data, and predict the value of the objective variable by applying the record of the new first ID to the prediction model corresponding to the cluster.

Furthermore, the predicting means may be configured to calculate a belonging probability that the new first ID belongs to each cluster of the first ID by using the value of the attribute included in the record of the new first ID or the data indicating a relation between the new first ID and the second ID in the second master data, predict a value of the objective variable by applying the record of the new first ID to each prediction model corresponding to each cluster of the first ID, and for each of the predicted values, fix a result obtained by weighting and adding the new first ID with the belonging probability that the new first ID belongs to each cluster, as the value of the objective variable.

Although the present invention has been described with reference to the exemplary embodiments, the present invention is not limited to the above exemplary embodiments. Various changes that can be understood by those skilled in the art within the scope of the present invention can be made to the configuration and details of the present invention.

This application claims priority based on Japanese Patent Application No. 2016-052737 filed on Mar. 16, 2016, the disclosure of which is incorporated herein in its entirety.

### INDUSTRIAL APPLICABILITY

The present invention is suitably applied to a co-clustering system which clusters two kinds of matters.

### REFERENCE SIGNS LIST

1 Co-clustering system
2 Data input unit
3 Processing unit
4 Storage unit
5 Result output unit
6 Test data input unit
7 Prediction unit
8 Prediction result output unit
31 Initialization unit
32 Clustering unit
321 Prediction model learning unit
322 Cluster assignment unit
323 Cluster information calculation unit
324 Cluster relation calculation unit
325 End determination unit

1. A co-clustering system comprising:
a co-clustering unit, implemented by a processor, that performs co-clustering processing that co-clusters first IDs and second IDs based on first master data, second master data, and fact data indicating a relation between the first ID which is an ID of a record in the first master data and the second ID which is an ID of a record in the second master data;
a prediction model generation unit, implemented by the processor, that executes prediction model generation processing that generates a prediction model for each cluster of at least the first ID; and
a determination unit, implemented by the processor, that determines whether or not a predetermined condition is satisfied, wherein
the prediction model generation processing and the co-clustering processing are repeated until it is determined that the predetermined condition is satisfied,
when the co-clustering unit determines a belonging probability that one first ID belongs to one cluster, a value of an objective variable corresponding to the first ID is predicted using the prediction model corresponding to the cluster, and as a difference between the value and an actual value is smaller, the belonging probability becomes higher.

2. The co-clustering system according to claim 1, comprising
a prediction unit, implemented by the processor, that predicts a value of the objective variable when test data including a record of a new first ID whose objective variable is unknown and data indicating a relation between the new first ID and the second ID in the second master data is given.

3. The co-clustering system according to claim 2, wherein
the predicting unit
specifies a cluster to which a new first ID belongs by using a value of an attribute included in a record of a new first ID or data indicating a relation between the new first ID and the second ID in the second master data, and
predicts a value of the objective variable by applying the record of the new first ID to a prediction model corresponding to the cluster.

4. The co-clustering system according to claim 2, wherein
the predicting unit
calculates a belonging probability that a new first ID belongs to each cluster of the first ID by using a value of an attribute included in a record of a new first ID or data indicating a relation between the new first ID and the second ID in the second master data, and
predicts a value of the objective variable by applying the record of the new first ID to each prediction model corresponding to each cluster of the first ID, and for each of the predicted values, fixes a result obtained by weighting and adding the new first ID with the belonging probability that the new first ID belongs to each cluster, as a value of the objective variable.

5. A co-clustering method comprising:
executing co-clustering processing that co-clusters first IDs and second IDs based on first master data, second master data, and fact data indicating a relation between the first ID which is an ID of a record in the first master data and the second ID which is an ID of a record in the second master data;
executing prediction model generation processing that generates a prediction model for each cluster of at least the first ID; and
determining whether or not a predetermined condition is satisfied, wherein
the prediction model generation processing and the co-clustering processing are repeated until it is determined that the predetermined condition is satisfied,
when a belonging probability that one first ID belongs to one cluster is determined in the co-clustering processing, a value of an objective variable corresponding to the first ID is predicted using the prediction model corresponding to the cluster, and as a difference between the value and an actual value is smaller, the belonging probability becomes higher.

6. A non-transitory computer-readable recording medium in which a co-clustering program is recorded, the co-clustering program causing a computer to execute:
co-clustering processing that co-clusters first IDs and second IDs based on first master data, second master data, and fact data indicating a relation between the first ID which is an ID of a record in the first master data and the second ID which is an ID of a record in the second master data;
prediction model generation processing that generates a prediction model for each cluster of at least the first ID; and
determining processing that determines whether or not a predetermined condition is satisfied, wherein
the prediction model generation processing and the co-clustering processing are caused to be repeated until it is determined that the predetermined condition is satisfied,
when a belonging probability that one first ID belongs to one cluster is determined in the co-clustering processing, a value of an objective variable corresponding to the first ID is caused to be predicted using the prediction model corresponding to the cluster, and as a difference between the value and an actual value is smaller, a belonging probability is caused to become higher.
